(19) United States
(12) Patent Application Publication
(10) Pub. No.: US 2006/0084492 A1
(43) Pub. Date: Apr. 20, 2006

(54) Gaming device having concentric reels and a displayable wild symbol

(76) Inventors: Anthony J. Baerlocher, Reno, NV (US); Ryan W. Cuddy, Reno, NV (US); Richard M. Pennington, Reno, NV (US)

Correspondence Address: Bell, Boyd & Lloyd LLC, P.O. Box 1135, Chicago, IL, 60690-1135, US

(21) Appl. No.: 10/949,619

(22) Filed: Sep. 24, 2004

(51) Int. Cl. A63F 13/00

(52) U.S. Cl. 463/20

(57) ABSTRACT

A gaming device including a plurality of reel sets where at least one of the reel sets includes an inner reel and an outer reel. The inner reel includes a plurality of first symbols and at least one designated symbol and the outer reel includes a plurality of second symbols and at least one viewable area which displays one or more of the first symbols of the inner reel. The outer reel remains stationary while the inner reel is moved or rotated. If the designated symbol is viewable or visible through the viewable area of the outer reel, the gaming device changes at least one of the second symbols of the outer reel to a wild symbol. The gaming device moves or rotates the outer reel to display or indicate one or more of the second symbols to a player. The gaming device evaluates the first and second symbols indicated by the reel sets and provides an outcome to the player for any winning symbol combinations indicated by one or more paylines associated with the reel sets.

### BACKGROUND OF THE INVENTION

The present invention relates in general to a gaming device, and more particularly to a gaming device having concentric reels having at least one wild symbol.

Contemporary gaming devices such as slot machines often include a primary game and one or more bonus rounds or bonus games. The primary games typically include the generation of one or more symbols using one or more symbol generators. The traditional symbol generators are a set of reels, where each reel has a plurality of symbols. If the player achieves a predetermined combination of symbols on the reels, the player wins a value. In addition, if the player achieves a bonus triggering event, the gaming device advances the player to a bonus game where the player can accumulate additional values. The traditional bonus triggering event occurs when the player achieves a predetermined symbol on one of the reels or a predetermined combination of symbols on a plurality of reels. If the combination of symbols indicated on the reels is not a predetermined symbol or symbol combination, the gaming device does not provide an award to the player.

Conventional gaming devices employ different symbols to form different winning symbol combinations in a game. Conventional gaming devices also employ different symbols which perform a function in a game. One such symbol is a wild symbol or wild card. Wild symbols provide a player with an additional opportunity to obtain winning combinations. Wild symbols, wild cards and wild indicators in gaming devices also provide additional excitement and entertainment for players.

In a slot machine having reels, a wild symbol can enable the matching of symbols along a payline to achieve a combination. For example, in a three reel slot machine, the symbols along a payline on the first, second and third reels may be, respectively, a heart, a heart and a wild symbol. If, in the gaming scheme, the gaming device awards a player for a three heart combination, the wild symbol substitutes for or functions as a heart and provides the player with that combination.

Concentric reels are also known in slot machines. A concentric reel includes an inner reel and an outer reel which are aligned on substantially the same rotational axis. The outer reel includes a plurality of symbols and at least one window. The inner reel includes a plurality of symbols. In a play of the game, the gaming device activates the concentric reels which causes the inner reel and the outer reel to move or rotate. When the inner and outer reel stop, one of the symbols of the outer reel or the window is indicated by a payline associated with the concentric reel. If the window is present on the payline, the window indicates or allows a player to see the symbol on the inner reel on the payline. The indicated symbol on the inner reel is part of the evaluated symbol combination with the other symbols of the other reels indicated by the payline. The gaming device provides an award for any winning symbol combination associated with these symbols indicated by the payline.

Players are attracted to gaming devices which provide new game schemes including different ways of obtaining winning symbol combinations or different types of triggering events. Therefore, to increase player enjoyment and excitement, it is desirable to provide players with new game schemes for gaming devices which include new and different ways of indicating symbol combinations and triggering events.

### SUMMARY OF THE INVENTION

The present invention relates in general to a gaming device, and more particularly to a gaming device including a slot game operable upon a wager and having concentric reels with at least one viewable area or window and at least one displayable wild symbol.

In one embodiment, the gaming device includes a plurality of reel sets where at least one of the reel sets includes concentric reels or concentrically arranged reels. The concentric reels include an inner reel which includes a plurality of first symbols having at least one designated symbol. The concentric reels also include an outer reel which includes a plurality of second symbols and defines at least one viewable area or window. In one embodiment, the outer reel is substantially transparent to enable a player to view or see the first symbols on the inner reel that are in corresponding positions to the second symbols on the outer reel. In one embodiment, the designated symbol on the inner reel is a wild symbol or acts as a wild symbol. It should be appreciated one, a plurality or all of the reel sets may include the inner reel and the outer reel described herein. It should also be appreciated that one, a plurality or all of the inner reels of the reel sets may include or display one or a plurality of the designated symbols.

In a play of the game, the gaming device activates the reel sets to indicate symbol combinations on the reel sets. On each reel set including the concentric inner and outer reels of the present invention, the gaming device causes the outer reels to remain in a fixed or stationary position displaying the viewable area or window to a player. The gaming device causes the inner reel to move or rotate or otherwise generate one or preferably a plurality of the first symbols on the inner reel. The gaming device also causes the other reel sets (which do not include the concentric reels) to display or generate symbols such as one or more of the first symbols. When the inner reel of each reel set including the concentric reels stops rotating or spinning, the gaming device evaluates the first symbols viewable through the viewable area on the outer reel of each of the reel sets having the concentric reels. If the designated symbol is viewable through the viewable area, the gaming device causes the outer reel to move or rotate to display or indicate one or more of the second symbols on the outer reel to the player. In one embodiment, the designated symbol also changes to, acts as or functions as a wild symbol in this play of the game. In one embodiment, at least one of the second symbols includes a modifier such as a multiplier. In other embodiments, a plurality of the second symbols include modifiers such as multipliers. It should be appreciated that any suitable number of the second symbols may be modifiers or any other suitable symbol. After the outer reel is moved or rotated, the gaming device evaluates the first and second symbols displayed by or indicated by the reel sets. More specifically, the gaming device provides an outcome such as an award to the player based on the first and second symbols indicated by the reel sets such as along one or more pay lines associated with the reel sets or in accordance with any scatter pays on the reel sets.

In another embodiment, the designated symbol changes at least one of the other displayed first symbols on the inner reel to a wild symbol or causes at least one of the displayed first symbols on the inner reel to act as a wild symbol when the designated symbol is viewable through the viewable area of the outer reel in a play of the game. In this embodiment, the designated symbol may also be a wild symbol. It should be appreciated that the designated symbol may change or cause at least one, a plurality or all of the displayed first symbols of the inner reel to be wild symbols in one or more plays of the game.

In another embodiment, all of the second symbols on the outer reels of each reel set including the concentric reels include modifiers such as multipliers. The modifier or multiplier multiplies any winning symbol combinations indicated on the paylines which indicate the modifier or multiplier. Thus, the modifier or multipliers further enhance the award or awards provided to a player in a play of the game and therefore increases the player's excitement and enjoyment of the game.

In a further embodiment, at least one of the modifiers on the outer reel acts as, is associated with or functions as a wild symbol. In this embodiment, the designated symbol or wild symbol on the inner reel acts as a trigger symbol to cause the outer reel to move or rotate to display or indicate one or a plurality of the modifiers on the outer reel. The designated symbol does not cause any of the other symbols to change to wild symbols. The symbol combinations indicated by the reel sets are evaluated and the gaming device provides any outcomes such as awards to the player based on winning symbol combinations indicated on one or more of the paylines associated with the reel sets. It should be appreciated that one, a plurality of all of the second symbols on the outer reel may include modifiers such as multipliers. It should also be appreciated that one, a plurality or all of the modifiers may also act as, function as or include wild symbols.

In another embodiment, the outer reel includes a plurality of symbol positions where at least one of the symbol positions includes a wild symbol. The other symbol positions that do not include a wild symbol, include blank symbols or other symbols such as conventional symbols. In this embodiment, the gaming device rotates or moves the outer reel of the reel sets including the concentric reels when the designated symbol is viewable through the viewable area of the outer reel. The gaming device then moves or rotates the outer reel to indicate one or more of the symbols including the wild symbol or symbols on the outer reel. The gaming device evaluates the symbol combinations indicated by the reel sets including any wild symbols on the outer reels of the reel sets to provide an outcome such as an award to the player in that play of the game. It should be appreciated that one of the symbol positions, a plurality of the symbol positions or all of the symbol positions of the outer reel may include a wild symbol. In another embodiment, the plurality of the first symbols of the inner reel include a designated symbol such as a wild symbol which causes or triggers the outer reel to move or rotate to display one or more of the second symbols of the outer reel in a play of the game. It should be appreciated that any suitable number of designated symbols may be displayed or generated by the inner reel. It should also be appreciated that the first symbols of the inner reel may include at least one modifier, at least one symbol, at least one wild symbol or any other suitable symbol.

In another embodiment, the gaming device activates or rotates the outer reel when one or more of the designated symbols are visible or viewable through the viewable area of the outer reel in a play of the game. The gaming device moves or rotates the outer reel to display one or more of the second symbols of the outer reel. The gaming device then re-activates or re-spins the other reel sets (which do not include concentric reels) to display a plurality of symbol combinations to the player in that play of the game. The gaming device evaluates the symbol combinations indicated by the reel sets and provides an outcome such as an award to the player for any winning symbol combinations indicated by the reel sets on one or more paylines associated with the reel sets.

In a further embodiment, the gaming device includes a plurality of reel sets where at least one of the reel sets includes the concentric reels described above. In this embodiment, the inner reel includes a plurality of first symbols having at least one designated symbol. The outer reel includes at least one viewable area or window and at least one of the first symbols. In a play of the game, when the reel sets are activated, the outer reel remains stationary while the inner reel rotates or spins. When the inner reel stops moving, the processor determines whether the designated symbols are indicated or visible through the viewable area on the outer reel. If the designated symbol is viewable through the viewable area on the outer reel, the processor moves or rotates the outer reel to indicate or display one or more of the first symbols on the outer reel. The processor then evaluates the symbol combinations indicated by the paylines in that play of the game. The gaming device provides an outcome such as an award to the player for any winning symbol combinations indicated by the paylines.

In one embodiment, the outer reel of the reel sets including the concentric reels described above remain stationary or fixed when the reel sets are activated in a play of the game. The outer reel remains stationary and fixed until one of the designated symbols on the inner reel is indicated or viewable through the viewable area on the outer reel. In another embodiment, the outer reel remains stationary or fixed for a designed number of plays of the game or for a designated number of activations of the reel sets. For example, if the designated symbol is not indicated by or viewable through the viewable area of the outer reel, in five activations of the reel sets, the processor causes the outer reel to move or rotate after the sixth activation of the reel sets. It should be appreciated that the designated number of plays in the game or activation of the reels may be randomly determined or predetermined.

In a further embodiment, the gaming device or processor evaluates the symbols indicated by the paylines a plurality of times in a game. For example, the processor evaluates the symbols associated with the reel sets after the designated symbol is indicated by the viewable area in the outer reel but before the inner reel is activated. The gaming device provides an outcome such as an award to the player for any winning symbol combinations indicated by the paylines before the outer reel is moved or rotated by the processor. The processor causes the outer reel to move or rotate to indicate the second symbols on the outer reel. The processor re-evaluates the second symbols on the outer reel and the first symbols on the other reel sets to determine if any winning symbol combinations occur on the paylines. The processor provides an additional outcome or outcomes to the player for any winning symbol combinations indicated by the paylines associated with the reel sets.

In another embodiment, the outer reels of each reel set including the concentric reels, are randomly activated in a play of the game. In this embodiment, the gaming device randomly activates one, a plurality or all of the outer reels of the reel sets including the concentric reels in a play of the game regardless of whether the designated symbol is viewable through the viewable area. In one example, the gaming device randomly activates the outer reel of the first reel set but not the outer reels of the other reel sets in the play of the game. It should be appreciated that any suitable number of the reel sets including the concentric reels may be randomly activated in a game.

In a further embodiment, the gaming device enables the player to make or place an extra or additional wager to activate one or more of the reel sets including the concentric reels in a play of the game. For example, in a gaming device including three reel sets each having the concentric reels described above, the gaming device enables the player to wager one credit to activate the outer reel of the first reel set, two credits to activate the outer reel of the first two reel sets, or three credits to activate all of the outer reels of the reel sets in the play of the game. It should be appreciated that any suitable wager amounts or any suitable number of the reel sets may be activated in a play of the game.

In another embodiment, the gaming device includes a plurality of reel sets where at least one of the reel sets including the concentric inner and outer reel described above. The outer reel includes at least one modifier such as a multiplier and defines at least one viewable area. In this embodiment, the gaming device enables the player to make or place an extra or additional wager to activate the designated symbol or wild symbol (i.e., activate the triggering feature of the designated symbol which causes the outer reel to move or rotate) when the designated symbol or wild symbol is viewable through the viewable area of the outer reel in a play of the game. Therefore, in this embodiment, the gaming device moves or rotates the outer reel of the reel sets including the inner and outer reel when the designated symbol or wild symbol is viewable through the viewable area of the outer reel and when the player makes the additional wager in the game to activate the trigger feature of the designated symbol or wild symbol. As a result, the modifier on the outer reel is displayed to the player when the designated symbol is viewable through the viewable area of the outer reel and when the player places the additional wager in the play of the game. It should be appreciated that any suitable wager amounts or any suitable number of designated symbols may be activated in a play of the game. It should also be appreciated that the outer reel of the reel sets including the inner and outer reel may include one or a plurality of modifiers such as multipliers in a play of the game.

In further embodiment, the gaming device enables the player to make or place an extra or additional wager to display one or more modifiers on one or more of the reel sets including the concentric reels. In this embodiment, one reel set, a plurality of the reel sets or all of the reel sets including the concentric reels display at least one modifier to a player based on the additional wager made by the player in a play of the game.

In another embodiment, the gaming device enables the player to make or place an extra or additional wager to activate one or more modifiers on the outer reels of one or more of the reel sets including the concentric reels. In this embodiment, the gaming device activates one or more of the modifiers displayed on the outer reels of the reel sets based on the additional wager made by the player in the play of the game. It should be appreciated that the gaming device may activate one, a plurality or all of the modifiers on the outer reels of the reels sets based on the additional wager made by the player.

Additional features and advantages of the present invention are described in, and will be apparent from, the following Detailed Description of the Invention and the Figures.

### BRIEF DESCRIPTION OF THE FIGURES

FIG. 1A is a perspective view of one embodiment of the gaming device of the present invention.

FIG. 1B is a perspective view of another embodiment of the gaming device of the present invention.

FIG. 2A is a schematic block diagram of the electronic configuration of one embodiment of the gaming device of the present invention.

FIG. 2B is a schematic block diagram illustrating the plurality of gaming terminals and communication with a central controller.

FIGS. 3A and 3B are enlarged perspective views of one embodiment of the concentric reels of the present invention where the outer reel includes a relatively large viewable area and the inner reel includes at least one designated symbol.

FIGS. 4A and 4B are enlarged elevation views of an example employing the at least one of the concentric reels of the embodiment of FIGS. 3A and 3B.

FIG. 4C is an enlarged elevation view of another embodiment of the concentric reels of FIGS. 3A and 3B where the outer reel includes a plurality of symbol positions and where all of the symbol positions do not include a second symbol.

FIGS. 5A and 5B are enlarged elevation views of an example of the embodiment of FIGS. 3A and 3B where the reel sets indicate a plurality of winning symbol combinations.

FIGS. 6A and 6B are enlarged elevation views of an example of another embodiment of the present invention where the reel set including the concentric reels has an outer reel defining a one symbol viewable area.

FIGS. 7A and 7B are enlarged elevation views of a further embodiment of the present invention where the designated symbol of the inner reel can be indicated at any one of the pay lines associated with the reel sets.

FIGS. 8A and 8B are enlarged elevation views of an example of another embodiment of the present invention where two of the reel sets include the concentric reels.

FIGS. 9A and 9B are enlarged elevation views of an example of a further embodiment of the present invention where the concentric reels include an inner reel having a designated symbol and an outer reel having at least one modifier associated with the designated symbol.

FIGS. 10 and 10B are enlarged elevation views of an example of another embodiment of the present invention where the concentric reels include an inner reel and an outer reel having at least one designated symbol.

FIGS. 11A and 11B are enlarged elevation views of another embodiment of the present invention where the concentric reels include an inner reel having a designated symbol and an outer reel having at least one symbol.

### DETAILED DESCRIPTION OF THE INVENTION

### Gaming Device and Electronics

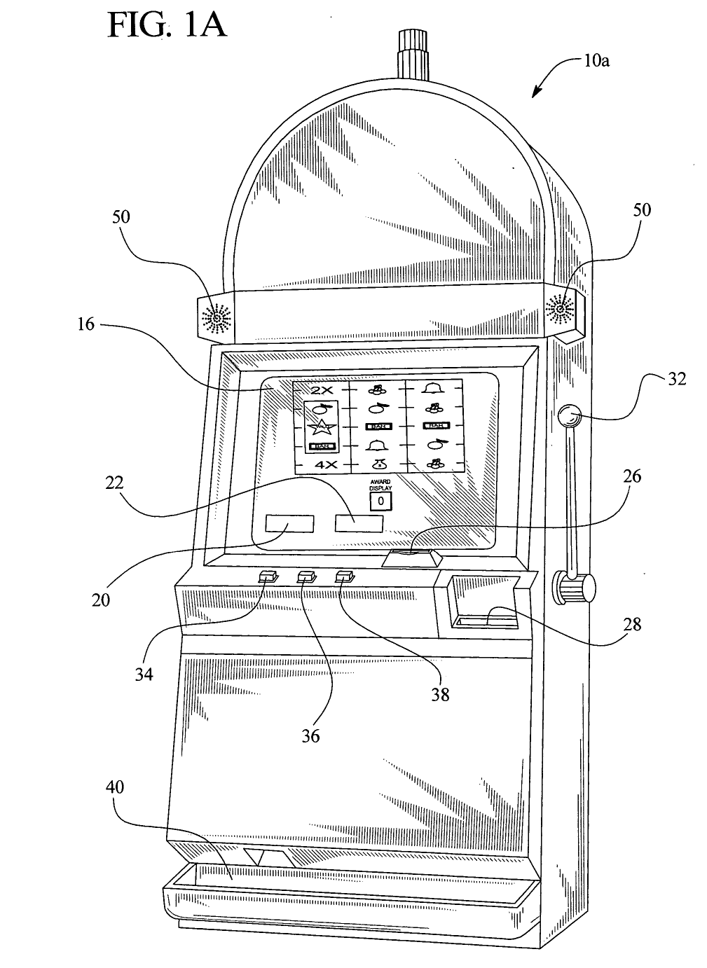

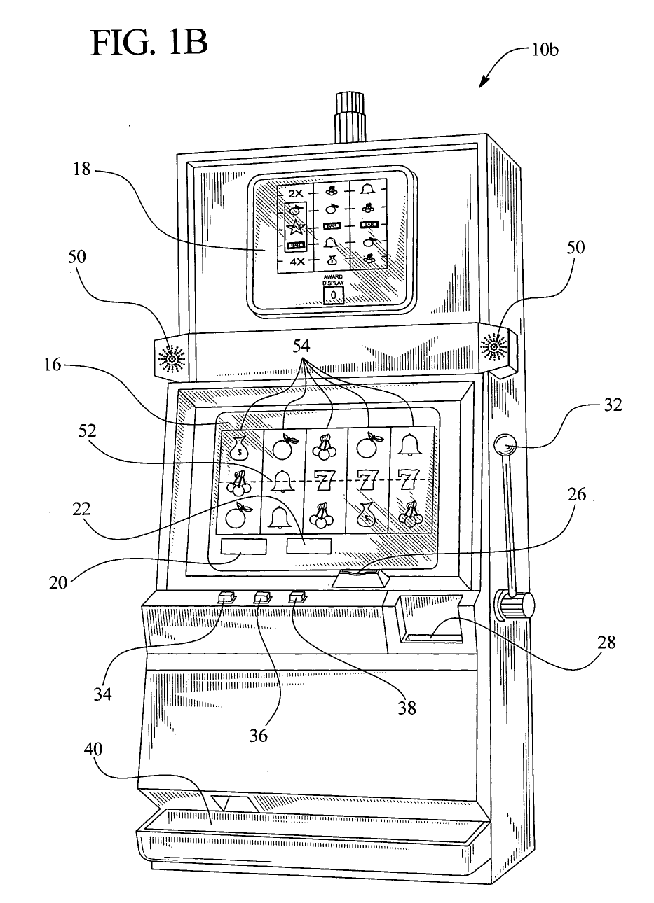

Referring now to the drawings, two alternative embodiments of the gaming device of the present invention are illustrated in FIGS. 1A and 1B as gaming device 10a and gaming device 10b, respectively. Gaming device 10a and/or gaming device 10b are generally referred to herein as gaming device 10.

In one embodiment, as illustrated in FIGS. 1A and 1B, gaming device 10 has a support structure, housing or cabinet which provides support for a plurality of displays, inputs, controls and other features of a conventional gaming machine. It is configured so that a player can operate it while standing or sitting. The gaming device may be positioned on a base or stand or can be configured as a pub-style table-top game (not shown) which a player can operate preferably while sitting. As illustrated by the different configurations shown in FIGS. 1A and 1B, the gaming device can be constructed with varying cabinet and display configurations.

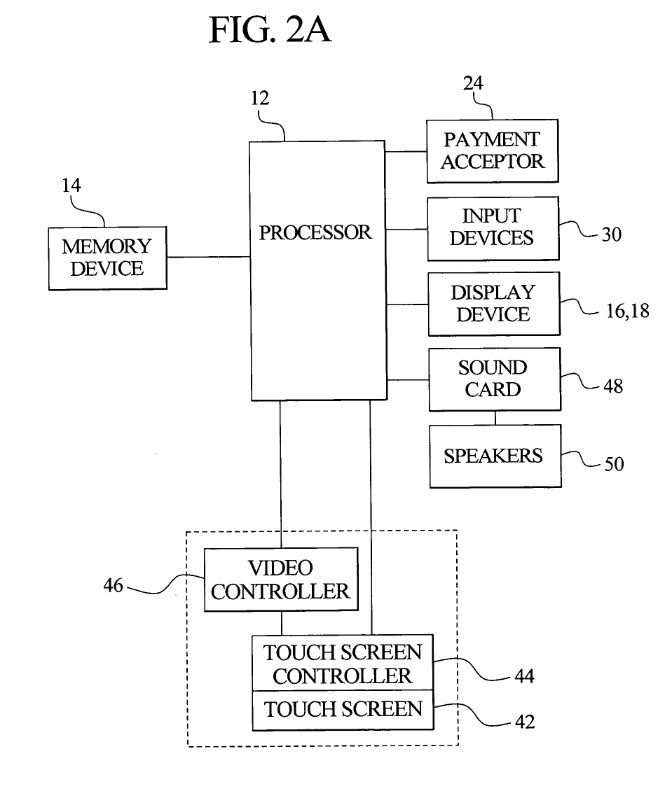

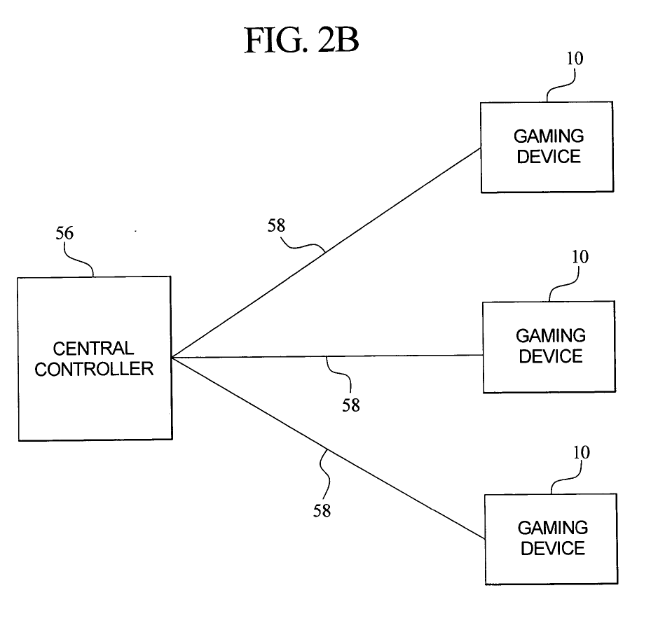

In one embodiment, as illustrated in FIG. 2A, the gaming device preferably includes at least one processor 12, such as a microprocessor, a microcontroller-based platform, a suitable integrated circuit or one or more application-specific integrated circuits (ASIC's). The processor is in communication with or operable to access or to exchange signals with at least one data storage or memory device 14. In one embodiment, the processor and the memory device reside within the cabinet of the gaming device. The memory device stores program code and instructions, executable by the processor, to control the gaming device. The memory device also stores other data such as image data, event data, player input data, random or pseudo-random number generators, pay-table data or information and applicable game rules that relate to the play of the gaming device. In one embodiment, the memory device includes random access memory (RAM). In one embodiment, the memory device includes read only memory (ROM). In one embodiment, the memory device includes flash memory and/or EEPROM (electrically erasable programmable read only memory). Any other suitable magnetic, optical and/or semiconductor memory may be implemented in conjunction with the gaming device of the present invention.

In one embodiment where the reels are in a video format, part or all of the program code and/or operating data described above can be stored in a detachable or removable memory device, including, but not limited to, a suitable cartridge, disk or CD ROM. A player can use such a removable memory device in a desktop, a laptop personal computer, a personal digital assistant (PDA) or other computerized platform. The processor and memory device may be collectively referred to herein as a “computer” or “controller.”

In one embodiment, as discussed in more detail below, the gaming device randomly generates awards and/or other game outcomes based on probability data. That is, each award or other game outcome is associated with a probability and the gaming device generates the award or other game outcome to be provided to the player based on the associated probabilities. In this embodiment, since the gaming device generates outcomes randomly or based upon a probability calculation, there is no certainty that the gaming device will ever provide the player with any specific award or other game outcome.

In another embodiment, as discussed in more detail below, the gaming device employs a predetermined or finite set or pool of awards or other game outcomes. In this embodiment, as each award or other game outcome is provided to the player, the gaming device removes the provided award or other game outcome from the predetermined set or pool. Once removed from the set or pool, the specific provided award or other game outcome cannot be provided to the player again. This type of gaming device provides players with all of the available awards or other game outcomes over the course of the play cycle and guarantees the amount of actual wins and losses.

In one embodiment, as illustrated in FIG. 2A, the gaming device includes one or more display devices controlled by the processor. The display devices are preferably connected to or mounted to the cabinet of the gaming device. The embodiment shown in FIG. 1A includes a central display device 16 which displays a primary game. This display device may also display any secondary game associated with the primary game as well as information relating to the primary or secondary game. The alternative embodiment shown in FIG. 1B includes a central display device 16 and an upper display device 18. The upper display device may display the primary game, any suitable secondary game associated with the primary game and/or information relating to the primary or secondary game. As seen in FIGS. 1A and 1B, in one embodiment, gaming device includes a credit display 20 which displays a player's current number of credits, cash, account balance or the equivalent. In one embodiment, gaming device includes a bet display 22 which displays a player's amount wagered.

The display devices may include, without limitation, a monitor, a television display, a plasma display, a liquid crystal display (LCD) a display based on light emitting diodes (LED) or any other suitable electronic device or display mechanism. In one embodiment, as described in more detail below, the display device includes a touch-screen with an associated touch-screen controller. The display devices may be of any suitable configuration, such as a square, rectangle, elongated rectangle.

The display devices of the gaming device are configured to display at least one and preferably a plurality of game or other suitable images, symbols and indicia such as any visual representation or exhibition of the movement of objects such as mechanical, virtual or video reels and wheels, dynamic lighting, video images, images of people, characters, places, things and faces of cards, tournament advertisements and the like.

In one alternative embodiment, the symbols, images and indicia displayed on or of the display device may be in mechanical form. That is, the display device may include any electromechanical device, such as one or more mechanical objects, such as one or more rotatable wheels, reels or dice, configured to display at least one and preferably a plurality of game or other suitable images, symbols or indicia.

As illustrated in FIG. 2A, in one embodiment, the gaming device includes at least one payment acceptor 24 in communication with the processor. As seen in FIGS. 1A and 1B, the payment acceptor may include a coin slot 26 and a payment, note or bill acceptor 28, where the player inserts money, coins or tokens. The player can place coins in the coin slot or paper money, ticket or voucher into the payment, note or bill acceptor. In other embodiments, devices such as readers or validators for credit cards, debit cards or credit slips could be used for accepting payment. In one embodiment, a player may insert an identification card into a card reader of the gaming device. In one embodiment, the identification card is a smart card having a programmed microchip or a magnetic strip coded with a player's identification, credit totals and other relevant information. In one embodiment, money may be transferred to a gaming device through electronic funds transfer. When a player funds the gaming device, the processor determines the amount of funds entered and the corresponding amount is shown on the credit or other suitable display as described above.

As seen in FIGS. 1A, 1B and 2A, in one embodiment the gaming device includes at least one and preferably a plurality of input devices 30 in communication with the processor. The input devices can include any suitable device which enables the player to produce an input signal which is read by the processor. In one embodiment, after appropriate funding of the gaming device, the input device is a game activation device, such as a pull arm 32 or a play button 34 which is used by the player to start any primary game or sequence of events in the gaming device. The play button can be any suitable play activator such as a bet one button, a max bet button or a repeat the bet button. In one embodiment, upon appropriate funding, the gaming device begins the game play automatically. In another embodiment, upon the player engaging one of the play buttons, the gaming device automatically activates game play.

In one embodiment, as shown in FIGS. 1A and 1B, one input device is a bet one button 36. The player places a bet by pushing the bet one button. The player can increase the bet by one credit each time the player pushes the bet one button. When the player pushes the bet one button, the number of credits shown in the credit display preferably decreases by one, and the number of credits shown in the bet display preferably increases by one. In another embodiment, one input device is a bet max button (not shown) which enables the player to bet the maximum wager permitted for a game of the gaming device.

In one embodiment, one input device is a cash out button 38. The player may push the cash out button and cash out to receive a cash payment or other suitable form of payment corresponding to the number of remaining credits. In one embodiment, when the player cashes out, the player receives the coins or tokens in a coin payout tray 40. In one embodiment, when the player cashes out, the player may receive other payout mechanisms such as tickets or credit slips redeemable by a cashier or funding to the player's electronically recordable identification card.

In one embodiment, as mentioned above and seen in FIG. 2A, one input device is a touch-screen 42 coupled with a touch-screen controller 44, or some other touch-sensitive display overlay to allow for player interaction with the images on the display. The touch-screen and the touch-screen controller are connected to a video controller 46. A player can make decisions and input signals into the gaming device by touching touch-screen at the appropriate places.

The gaming device may further include a plurality of communication ports for enabling communication of the processor with external peripherals, such as external video sources, expansion buses, game or other displays, an SCSI port or a key pad.

In one embodiment, as seen in FIG. 2A, the gaming device includes a sound generating device controlled by one or more sounds cards 48 which function in conjunction with the processor. In one embodiment, the sound generating device includes at least one and preferably a plurality of speakers 50 or other sound generating hardware and/or software for generating sounds, such as playing music for the primary and/or secondary game or for other modes of the gaming device, such as an attract mode. In one embodiment, the gaming device provides dynamic sounds coupled with attractive multimedia images displayed on one or more of the display devices to provide an audio-visual representation or to otherwise display full-motion video with sound to attract players to the gaming device. During idle periods, the gaming device may display a sequence of audio and/or visual attraction messages to attract potential players to the gaming device. The videos may also be customized for or to provide any appropriate information.

In one embodiment, the gaming machine may include a player or other sensor, such as a camera in communication with the processor (and possibly controlled by the processor) that is selectively positioned to acquire an image of a player actively using the gaming device and/or the surrounding area of the gaming device. In one embodiment, the camera may be configured to selectively acquire still or moving (e.g., video) images and may be configured to acquire the images in either an analog, digital or other suitable format. The display devices may be configured to display the image acquired by the camera as well as display the visible manifestation of the game in split screen or picture-in-picture fashion. For example, the camera may acquire an image of the player and that image can be incorporated into the primary and/or secondary game as a game image, symbol or indicia.

Gaming device 10 can incorporate any suitable wagering primary or base game. The gaming machine or device of the present invention may include some or all of the features of conventional gaming machines or devices. The primary or base game may comprise any suitable reel-type game, card game, number game or other game of chance susceptible to representation in an electronic or electromechanical form which produces a random outcome based on probability data upon activation from a wager. That is, different primary wagering games, such as video poker games, video blackjack games, video Keno, video bingo or any other suitable primary or base game may be implemented into the present invention.

In one embodiment, as illustrated in FIGS. 1A and 1B, a base or primary game may be a slot game with one or more paylines 52. The paylines may be horizontal, vertical, circular, diagonal, angled or any combination thereof. In this embodiment, the gaming device displays at least one and preferably a plurality of reels 54, such as three to five reels 54 in either electromechanical form with mechanical rotating reels or video form with simulated reels and movement thereof. In one embodiment, an electromechanical slot machine includes a plurality of adjacent, rotatable wheels which may be combined and operably coupled with an electronic display of any suitable type. In another embodiment, if the reels 54 are in video form, the plurality of simulated video reels 54 are displayed on one or more of the display devices as described above. Each reel 54 displays a plurality of indicia such as bells, hearts, fruits, numbers, letters, bars or other images which preferably correspond to a theme associated with the gaming device. In this embodiment, the gaming device awards prizes when the reels of the primary game stop spinning if specified types and/or configurations of indicia or symbols occur on an active pay line or otherwise occur in a winning pattern.

In one embodiment, a base or primary game may be a keno game wherein the gaming device displays a plurality of selectable indicia or numbers on at least one of the display devices. In this embodiment, the player selects at least one and preferable a plurality of the selectable indicia or numbers via an input device or via the touch screen. The gaming device then displays a series of drawn numbers to determine an amount of matches, if any, between the player's selected numbers and the gaming device's drawn numbers. The player is provided an award based on the amount of matches, if any, based on the amount of determined matches.

In one embodiment, in addition to winning credits in a base or primary game, the gaming device may also give players the opportunity to win credits in a bonus or secondary game or bonus or secondary round. The bonus or secondary game enables the player to obtain a prize or payout in addition to the prize or payout, if any, obtained from the base or primary game. In general, a bonus or secondary game produces a significantly higher level of player excitement than the base or primary game because it provides a greater expectation of winning than the base or primary game and is accompanied with more attractive or unusual features than the base or primary game.

In one embodiment, the bonus or secondary game may be any type of suitable game, either similar to or completely different from the base or primary game. In one embodiment, the gaming device includes a program which will automatically begin a bonus round when the player has achieved a triggering event or qualifying condition in the base or primary game. In one embodiment, the triggering event or qualifying condition may be a selected outcome in the primary game or a particular arrangement of one or more indicia on a display device in the primary game, such as the number seven appearing on three adjacent reels along a payline in the primary slot game embodiment seen in FIGS. 1A and 1B. In another embodiment, the triggering event or qualifying condition may be by exceeding a certain amount of game play (number of games, number of credits, amount of time), reaching a specified number of points earned during game play or as a random award.

In one embodiment, once a player has qualified for a bonus game, the player may subsequently enhance his/her bonus game participation through continued play on the base or primary game. Thus, for each bonus qualifying event, such as a bonus symbol, that the player obtains, a given number of bonus game wagering points or credits may be accumulated in a “bonus meter” programmed to accrue the bonus wagering credits or entries toward eventual participation in a bonus game. The occurrence of multiple such bonus qualifying events in the primary game may result in an arithmetic or geometric increase in the number of bonus wagering credits awarded. In one embodiment, extra bonus wagering credits may be redeemed during the bonus game to extend play of the bonus game.

In one embodiment, no separate entry fee or buy in for a bonus game need be employed. That is, a player may not purchase an entry into a bonus game; he must win or earn entry through play of the primary game and, thus, play of the primary game is encouraged. In another embodiment, qualification of the bonus or secondary game could be accomplished through a simple “buy in” by the player if, for example, the player has been unsuccessful at qualifying through other specified activities.

In one embodiment, as illustrated in FIG. 2B, one or more of the gaming devices 10 of the present invention may be connected to each other through a data network or a remote communication link 58 with some or all of the functions of each gaming device provided at a central location such as a central server or central controller 56. More specifically, the processor of each gaming device may be designed to facilitate transmission of signals between the individual gaming device and the central server or controller.

In one embodiment, the game outcome provided to the player is determined by a central server or controller and provided to the player at the gaming device of the present invention. In this embodiment, each of a plurality of such gaming devices are in communication with the central server or controller. Upon a player initiating game play at one of the gaming devices, the initiated gaming device communicates a game outcome request to the central server or controller.

In one embodiment, the central server or controller receives the game outcome request and randomly generates a game outcome for the primary game based on probability data. In another embodiment, the central server or controller randomly generates a game outcome for the secondary game based on probability data. In another embodiment, the central server or controller randomly generates a game outcome for both the primary game and the secondary game based on probability data. In this embodiment, the central server or controller is capable of storing and utilizing program code or other data similar to the processor and memory device of the gaming device.

In an alternative embodiment, the central server or controller maintains one or more predetermined pools or sets of predetermined game outcomes. In this embodiment, the central server or controller receives the game outcome request and independently selects a predetermined game outcome from a set or pool of game outcomes. The central server or controller flags or marks the selected game outcome as used. Once a game outcome is flagged as used, it is prevented from further selection from the set or pool and cannot be selected by the central controller or server upon another wager. The provided game outcome can include a primary game outcome, a secondary game outcome, primary and secondary game outcomes, or a series of game outcomes such a free games.

The central server or controller communicates the generated or selected game outcome to the initiated gaming device. The gaming device receives the generated or selected game outcome and provides the game outcome to the player. In an alternative embodiment, how the generated or selected game outcome is to be presented or displayed to the player, such as a reel symbol combination of a slot machine or a hand of cards dealt in a card game, is also determined by the central server or controller and communicated to the initiated gaming device to be presented or displayed to the player. Central production or control can assist a gaming establishment or other entity in maintaining appropriate records, controlling gaming, reducing and preventing cheating or electronic or other errors, reducing or eliminating win-loss volatility and the like.

In another embodiment, one or more of the gaming devices of the present invention are in communication with a central server or controller for monitoring purposes only. That is, each individual gaming device randomly generates the game outcomes to be provided to the player and the central server or controller monitors the activities and events occurring on the plurality of gaming devices. In one embodiment, the gaming network includes a real-time or on-line accounting and gaming information system operably coupled to the central server or controller. The accounting and gaming information system of this embodiment includes a player database for storing player profiles, a player tracking module for tracking players and a credit system for providing automated casino transactions.

A plurality of the gaming devices of the present invention are capable of being connected together through a data network. In one embodiment, the data network is a local area network (LAN), in which one or more of the gaming devices are substantially proximate to each other and an on-site central server or controller as in, for example, a gaming establishment or a portion of a gaming establishment. In another embodiment, the data network is a wide area network (WAN) in which one or more of the gaming devices are in communication with at least one off-site central server or controller. In this embodiment, the plurality of gaming devices may be located in a different part of the gaming establishment or within a different gaming establishment than the off-site central server or controller. Thus, the WAN may include an off-site central server or controller and an off-site gaming device located within gaming establishments in the same geographic area, such as a city or state. The WAN gaming system of the present invention may be substantially identical to the LAN gaming system described above, although the number of gaming devices in each system may vary relative to each other.

In another embodiment, the data network is an internet or intranet. In this embodiment, the operation of the gaming device can be viewed at the gaming device with at least one internet browser. In this embodiment, operation of the gaming device and accumulation of credits may be accomplished with only a connection to the central server or controller (the internet/intranet server) through a conventional phone or other data transmission line, digital signal line (DSL), T-1 line, coaxial cable, fiber optic cable, or other suitable connection. In this embodiment, players may access an Internet game page from any location where an internet connection and computer, or other internet facilitator are available. The expansion in the number of computers and number and speed of internet connections in recent years increases opportunities for players to play from an ever-increasing number of remote sites. It should be appreciated that enhanced bandwidth of digital wireless communications may render such technology suitable for some or all communications according to the present invention, particularly if such communications are encrypted. Higher data transmission speeds may be useful for enhancing the sophistication and response of the display and interaction with the player.

In another embodiment, a plurality of gaming devices at one or more gaming sites may be networked to a central server in a progressive configuration, as known in the art, wherein a portion of each wager to initiate a base or primary game may be allocated to bonus or secondary event awards. In one embodiment, a host site computer is coupled to a plurality of the central servers at a variety of mutually remote gaming sites for providing a multi-site linked progressive automated gaming system. In one embodiment, a host site computer may serve gaming devices distributed throughout a number of properties at different geographical locations including, for example, different locations within a city or different cities within a state.

In one embodiment, the host site computer is maintained for the overall operation and control of the system. In this embodiment, a host site computer oversees the entire progressive gaming system and is the master for computing all progressive jackpots. All participating gaming sites report to, and receive information from, the host site computer. Each central server computer is responsible for all data communication between the gaming device hardware and software and the host site computer.

### Concentric Reels and Displayable Wild Symbol

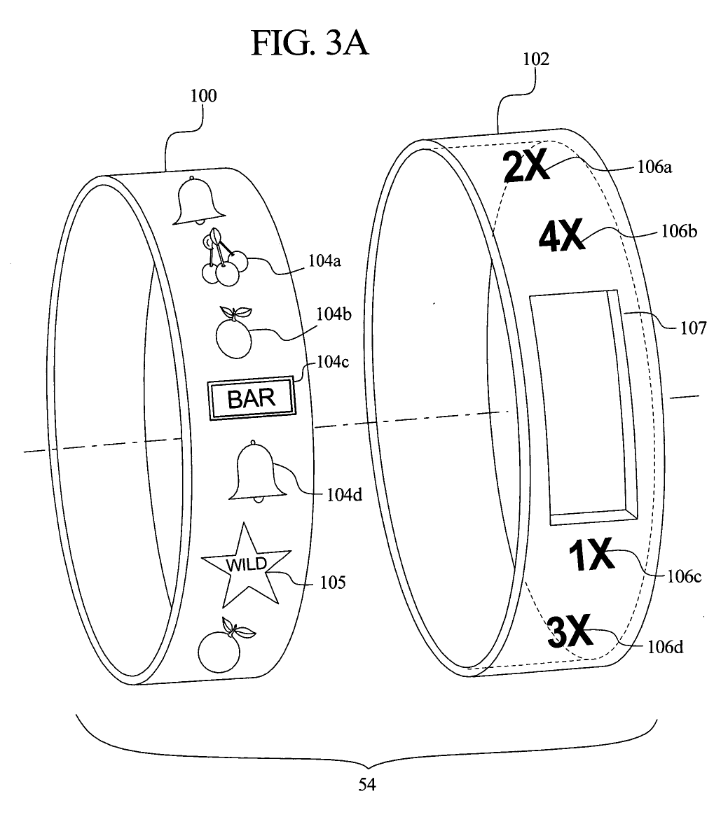

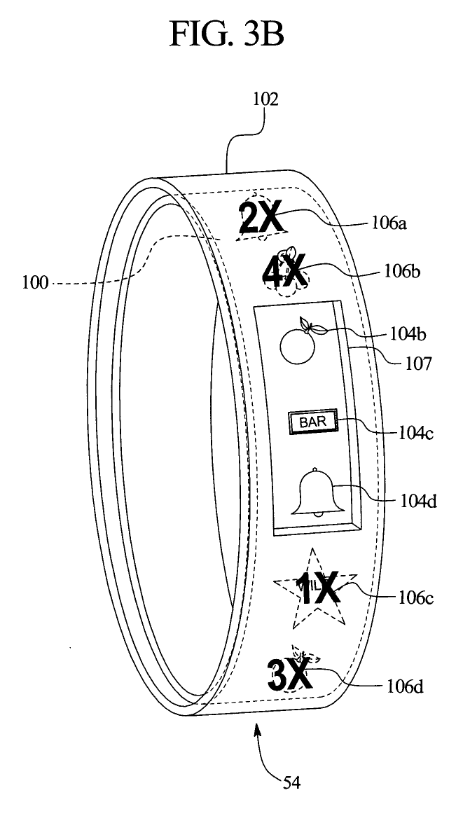

Referring now to FIGS. 1A, 1B, 3A and 3B, in one embodiment, the present invention is directed to a gaming device including a plurality of symbol generators such as reel sets 54 where at least one of the reel sets includes concentric reels such as the symbol display or inner reel 100 and a viewable area symbol display or outer reel 102. In this embodiment, the symbol display or inner reel 100 includes at least one designated symbol or triggering symbol such as a wild symbol 105 illustrated in FIG. 3A. It should be appreciated that the inner reel 100 may include one or more designated symbol or wild symbols. In this embodiment, the designated symbol or wild symbol is in the shape of a star. It should be appreciated that the designated symbol or wild symbol may be any suitable symbol.

In one embodiment, the viewable area display or outer reel 102 is substantially transparent and includes at least one second symbol such as a modifier symbol or modifier, and preferably a plurality of modifier symbols or modifiers such as multipliers 106a, 106b, 106c and 106d shown in FIG. 3A. The transparent outer reel enables a player to see or view the first symbols on the inner reel that are positioned beneath each of the second symbols on the outer reel. The outer reel 102 also includes or defines a viewable area or window 107. The viewable area or window 107 enables a player to view one or more of the symbols 104 of the inner reel 100 through the outer reel 102. The viewable area or window 107 is cut out or otherwise suitably defined by the outer reel 102. In the illustrated embodiment, the viewable area or window 107 extends completely through the thickness or width of the outer reel 102 where the window 104 is open or uncovered. In another embodiment, a see-through or transparent material, such as glass or clear plastic, is positioned in an opening in an outer reel and attached to the outer reel 102 forming the viewable area or window 107 and enabling a player to see through the window 107. It should be appreciated that any suitable material may be used to form the outer reel and/or the window 107. It should also be appreciated that the window 107 may be any suitable size or shape. As illustrated in FIG. 3A, in one embodiment, the viewable area or window 107 is a relatively large window which displays all of the displayed first symbols of the inner reel 100. It should be appreciated that for illustrative purposes, most of the figures display five symbol positions on each of the reel sets. It should be appreciated that the reel sets of the gaming device of the present invention display symbols based on conventional gaming devices which typically display a three by three symbol matrix (i.e., three reel sets having three symbol positions displayed on each reel set) or a five by five symbol matrix (i.e., five reel sets having three symbol positions displayed on each reel set). It should be appreciated that any suitable symbol matrix may be employed by the gaming device of the present invention. It should also be appreciated that in the illustrated embodiment, the outer reel 102 includes one viewable area or window. In another embodiment, the outer reel 102 includes a plurality of viewable areas or windows.

In a play of the game, the gaming device or player actives the reel sets 54 displayed by the gaming device. In one embodiment, one of the reel sets includes the concentric reels described above and the other reels sets are conventional reels or reel sets displaying one or more of the first symbols. It should be appreciated that the other reel sets may display one or more of the first symbols, second symbols or any other suitable symbols. In this embodiment, the gaming device causes the inner reel to move or rotate upon the activation of the reel sets and maintains or keeps the outer reel 102 fixed in position or stationary. When the outer reel 102 is stationary, the viewable area or window 107 is positioned or displayed to the player so the player can see through the viewable area or window to see the first symbols on the inner reel 100 as the inner reel 100 moves or rotates during the play of the game. When the inner reel 100 stops moving or spinning, certain of the first symbols are indicated or viewable through the viewable area or window 107. The other of the first symbols are visible through the other portions of the transparent outer reel. The number of symbols (i.e., symbol positions) viewable through the viewable area or window is based on the size of the viewable area or window. In the illustrated embodiment, the window 107 is sized to display all of the displayed first symbols of the inner reel (i.e., three of the first symbols). When the designated symbol or wild symbol 105 is indicated or viewable through the viewable area or window 107 in a play of the game, the wild symbol 105 triggers or causes the outer reel to move or rotate to display one or more of the second symbols on the outer reel to the player. Additionally, the wild symbol 105 changes to or acts as a wild symbol in this play of the game. The gaming device or processor evaluates the symbol combinations indicated by each payline associated with the reel sets to determine if one or more designated symbol combinations such as winning symbol combinations occur on one or more of the paylines. The gaming device provides an outcome such as an award to a player for winning symbol combinations indicated by the paylines where the award or awards are modified by the modifier indicated on each payline which indicates a winning symbol combination.

As described above, the combination of the viewable area on the outer reel and the designated symbol or wild symbol on the inner reel provides excitement and enjoyment for players because the player have more opportunities to obtain an award in a play of the game and potentially a plurality of awards or a very large award in each play of the game.

Referring more specifically to FIGS. 3A and 3B, an example of the concentric reels of the above embodiment is illustrated where the outer reel 102 includes a viewable or window 107 which is sized to display a plurality of the first symbols of the inner reel 100. The outer reel 102 also includes a plurality of modifiers such as the multiplier of 2× labeled 106a, the multiplier of 4× labeled 106b, the multiplier of 1× labeled 106c and the multiplier of 3× labeled 106d. As described above, the outer reel 102 is substantially transparent or see-through so that a player can view or see the first symbols of the inner reel 100 which are positioned below or beneath the outer reel 102. In this embodiment, the inner reel 100 includes at least one wild symbol 105 and a plurality of conventional symbols such as a cherry symbol 104a, an orange symbol 104b, a bar symbol 104c and a bell symbol 104d. In this embodiment, the wild symbol 105 is in the shape of a star. It should be appreciated that the wild symbol may be any suitable symbol, image, character or other symbol desired by the game implementor. It should also be appreciated that the other symbols of inner reel 100 may be any suitable symbols or images.

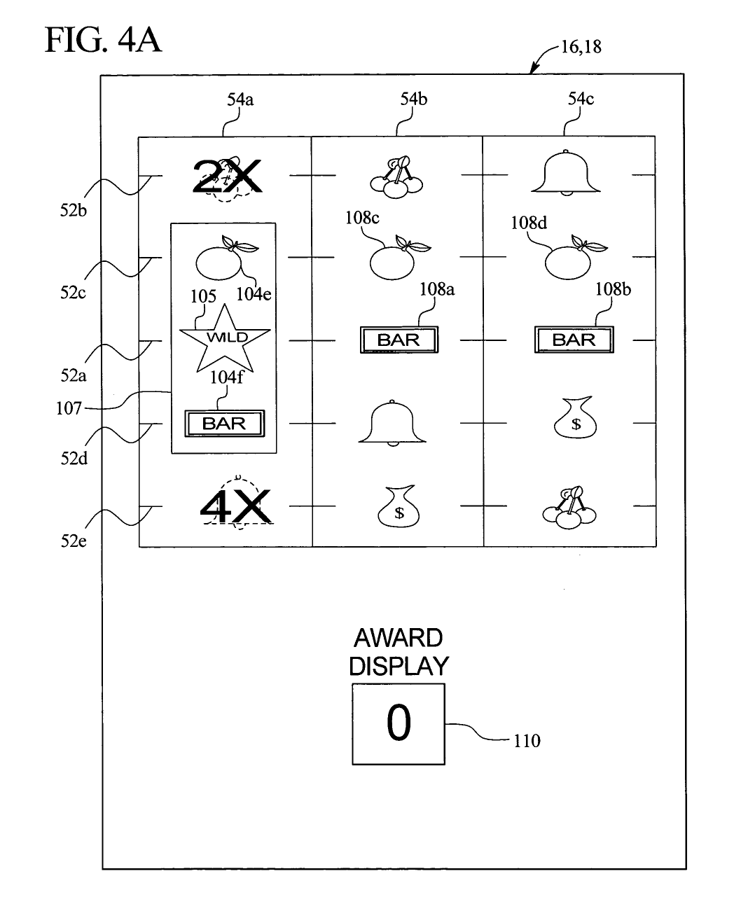

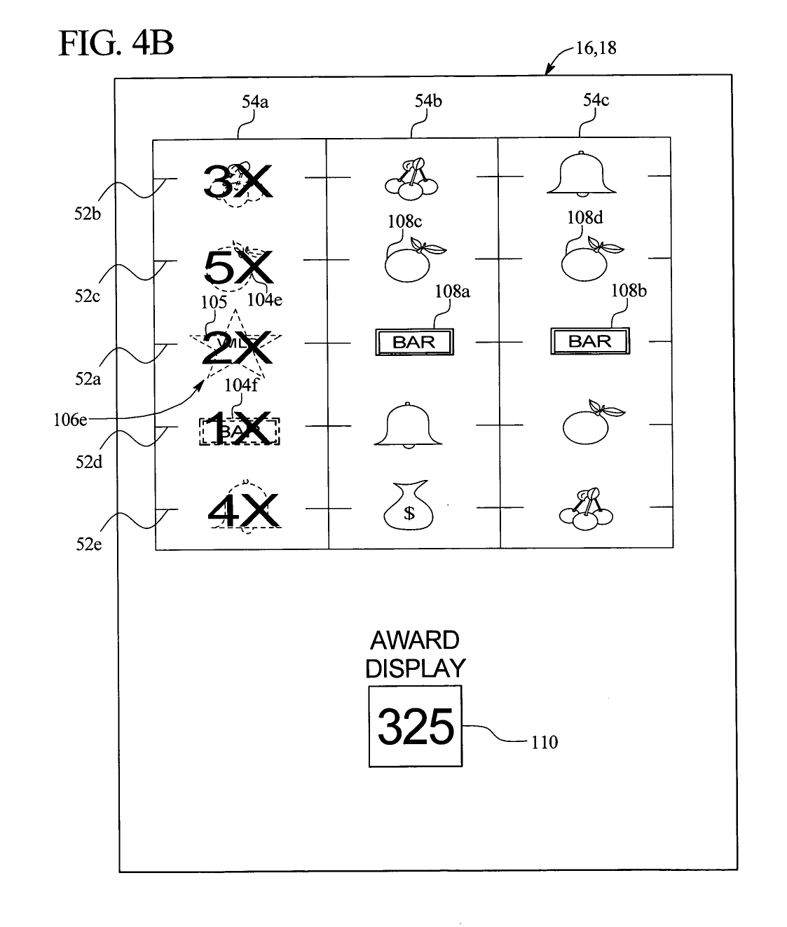

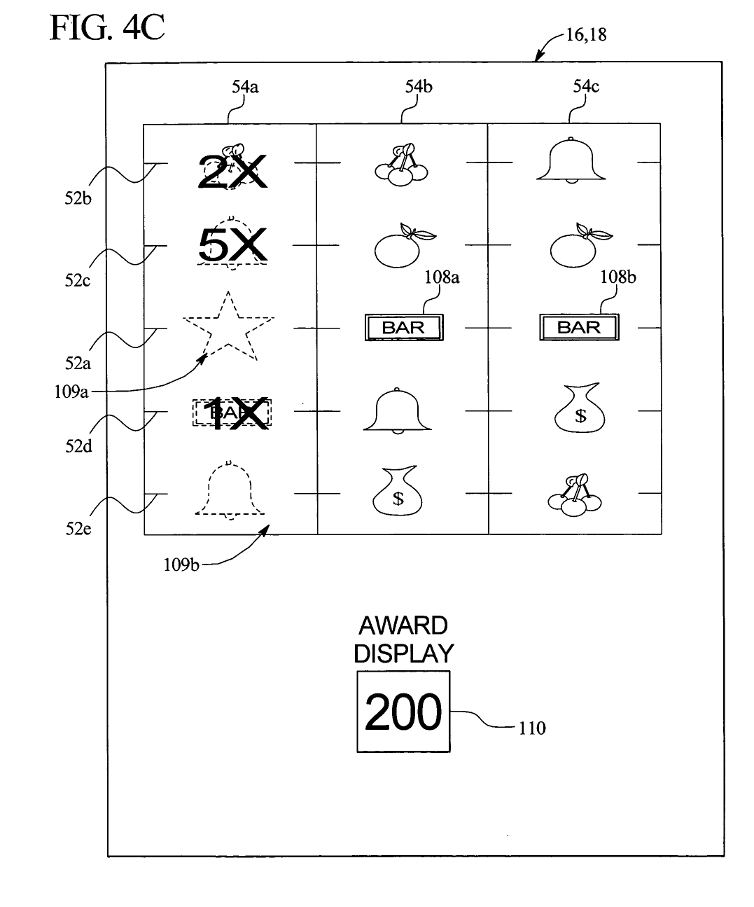

Referring now to FIGS. 4A and 4B, an example of a gaming device employing the concentric reels of FIGS. 3A and 3B is illustrated where the gaming device includes three reel sets 54a, 54b, and 54c. In this embodiment, the left reel set 54a includes concentric reels 100 and 102 of FIGS. 3A and 3B. The other reel sets 54b and 54c do not include concentric reels and each display a plurality of symbols such one or more of the first symbols. Reel set 54a includes a viewable area 107 which is sized to display three symbol positions or all of the displayed symbols of the inner reel as described above. Reel set 54a also includes at least one second symbol or modifier such as the multipliers of 2× and 4× shown in FIG. 4A. It should be appreciated that at least one of the modifiers, a plurality of the modifiers or all the modifiers may be different on the outer reel. It should further be appreciated that all of the modifiers be the same. The other reel sets 54b and 54c include a plurality of conventional symbols as illustrated in FIG. 4A. A plurality of paylines 52a, 52b, 52c, 52d and 52e are associated with the reel sets 54a, 54b and 54c. The paylines indicate symbol combinations displayed by the reel sets in each play of the game. In this example, the gaming device provides an outcome such as an award to a player when three identical symbols are indicated on any one of the paylines 52a, 52b, 52c, 52d and 52e. An award display 110 indicates the award provided to the player in a play of the game.

In the illustrated embodiment, the gaming device or player activates the reel sets 54a, 54b, 54c, 54d and 54e in a play of the game. In one embodiment, the outer reel including the viewable area 107 remains stationary or fixed while the inner reel 100 moves or rotates upon the activation of the reel sets. The inner reel of reel set 54a may rotate at the same rate or at a different rate of rotation as reel sets 54b and 54c. Additionally, reel sets 54b and/or 54c may stop moving or may rotate at the same time or at different times from the inner reel of reel set 54a.

In this example, the reel sets 54a, 54b and 54c stop spinning and indicate symbols on paylines 52a, 52b, 52c, 52d and 52e. Specifically, payline 52a indicates the wild symbol 105 viewable through viewable area 107, a bar symbol 108a and a bar symbol 108b. As described above, because the wild symbol 105 is viewable through the viewable area or window 107 and is thereby indicated by one of the paylines associated with the reel sets 54a, 54b and 54c, the gaming device or processor causes the outer reel of reel set 54a to rotate or move to indicate or display the multipliers on each of the paylines. Additionally as described above, the wild symbol 105 causes each of the symbols of the inner reel to be, act as or function as wild symbols in the play of the game. It should be appreciated that the outer reel remains stationary or fixed and thereby the viewable area or window remains stationary or fixed in position until the wild symbol 105 is visible or viewable through the viewable area or window of the outer reel.

Referring now to FIG. 4B, the outer reel of reel sets 54a moves or rotates to display the multipliers to the player such as the multipliers of 3× on payline 52b, 5× on payline 52c, 2× on paylines 52a, 1× on payline 52d and 4× on payline 52e as illustrated in FIG. 4B. The player can also see or view the first symbols on the inner reel, which are adjacent to and beneath the multipliers, through the substantially transparent outer reel. The modifiers or multipliers multiply any awards provided to the player for the symbol combinations indicated by each of the paylines. As illustrated in FIG. 4B, payline 52a includes the wild symbol 105, a bar symbol 108a and a bar symbol 108b. The wild symbol 105 combines with the bar symbols 108a and 108b to generate or indicate a symbol combination including three bar symbols on payline 52a. Therefore, a winning symbol combination including three bar symbols is indicating by payline 52a. Additionally, payline 52c indicates a winning symbol combination including three orange symbols—orange symbol 104e, orange symbol 108c and orange symbol 108d. A winning symbol combination including three bar symbols provides an award of one hundred to the player. Additionally, a winning symbol combination including three orange symbol provides an award of twenty-five to the player. Therefore, the gaming device multiplies or modifies the award of one hundred by the multiplier of 2× labeled 106e which is indicated by payline 52a. The gaming device multiplies the award of twenty-five by the multiplier of 5× indicated by payline 52c. The gaming device sums the resultant awards of two hundred and one hundred twenty-five to provide a total award of three hundred twenty-five to the player. The total award of three hundred twenty-five is provided to the player in this play of the game as indicated by the award display 110.

The above example illustrates how the wild symbol enhances the player's opportunity to obtain more awards and potentially a very large award in each play of the game. For example in FIG. 4B, payline 52a indicated a wild symbol 105, the bar symbol 108a and the bar symbol 108b, which is a winning symbol combination including three bar symbols. Payline 52c also indicated a winning symbol combination in the game. Therefore, the player obtained two awards in this play of the game due to the wild symbol where the player would have only received one award in the play of the game.

In one embodiment, when a plurality of winning symbol combinations are indicated by the paylines in a play of the game, the gaming device provides the largest award associated with the winning symbol combinations to the player. In another embodiment, the gaming device provides each award associated with the winning symbol combinations to the player. In this embodiment the gaming device sums or adds the awards together and provides the player with a total award for that play of the game. It should be appreciated that the gaming device may sum, multiply or otherwise modify the awards associated with each winning symbol combination in a play of the game. It should also be appreciated that the gaming device may provide any suitable number of the awards to the player in a play of the game.

Referring now to FIG. 4C, a further embodiment of the present invention is illustrated where the outer reel of reel set 54a includes a plurality of symbol positions. In this embodiment, one or more of the symbol positions, but not all of the symbol positions, include one of the second symbols such as a modifier or multiplier. It should be appreciated that one or more of the symbol positions may include a second symbol such as a modifier or multiplier in a game.

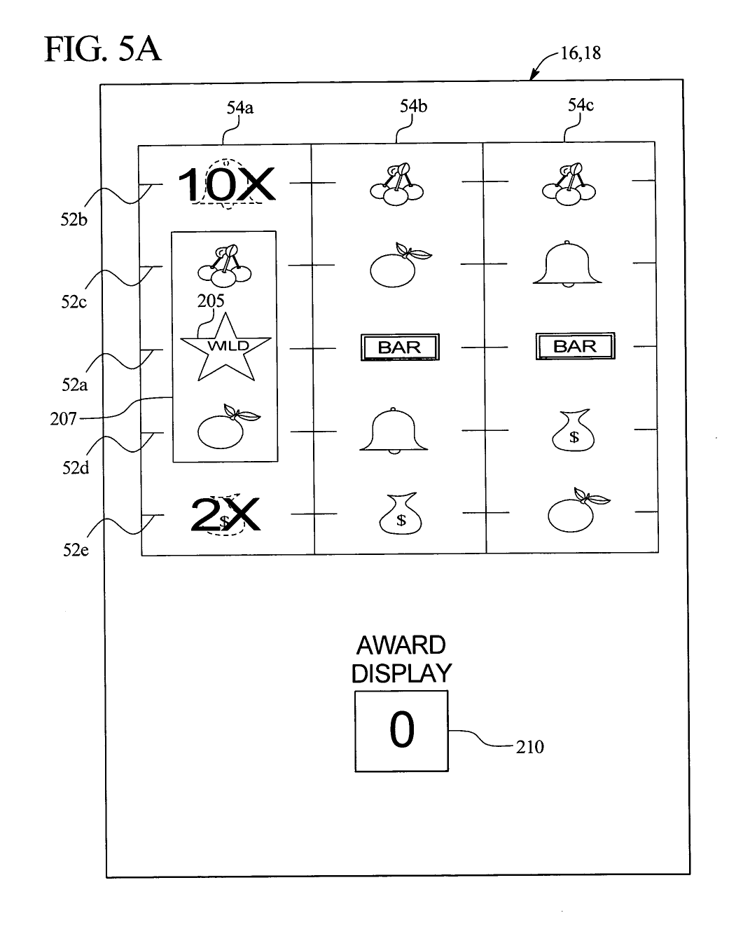

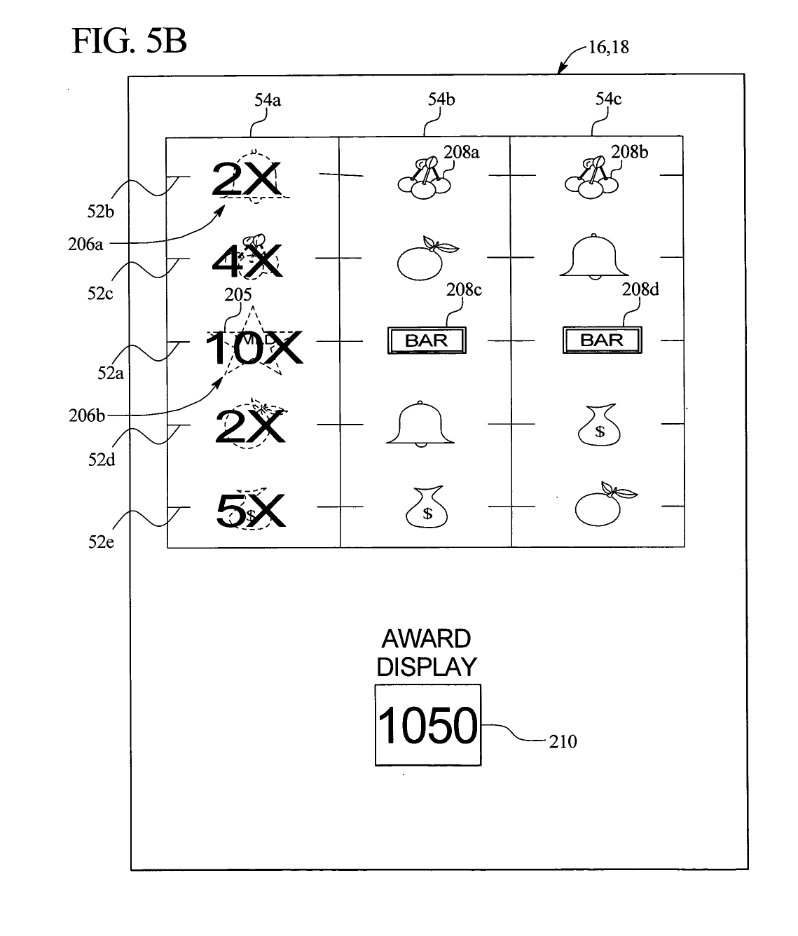

Referring now to FIGS. 5A and 5B, another example of the embodiment of FIGS. 3A and 3B is illustrated where the designated symbol or wild symbol changes at least one of the first symbols on the inner reel to a wild symbol or causes at least one of the first symbols on the inner reel to act as or function as a wild symbol. It should be appreciated that the designated symbol or wild symbol may change one, a plurality or all of the first symbols on the inner reel to be, act as or function as wild symbols in a game. In the illustrated example, the designated symbol or wild symbol causes a plurality of winning symbol combinations to be indicated on the paylines associated with reel sets 54a, 54b and 54c. In FIG. 5A, the gaming device or player activates the reel sets 54a, 54b and 54c in a play of the game. During the activation of the reel sets, the outer reel remains stationary until a wild symbol is viewable or visible through the viewable area or window 207. After the reel sets stop moving or spinning, a wild symbol 205 is displayed by the viewable area or window 207 of reel set 54a. Therefore, the gaming device causes the outer reel of reel set 54a to move or rotate to indicate modifiers such as the multipliers of 10× and 2× shown in FIG. 5A. In this example, the wild symbol 205 also changes or causes all of the first symbols of the inner reel to be or act as wild symbols. The other reel sets 54a, 54b and 54c do not move or spin again or are not re-activated in the play of the game. It should be appreciated that the reel set including the concentric reels or any of the other reel sets may be re-activated one time or a plurality times in a play of the game.

Referring now to FIG. 5B, after the outer reel of reel set 54a stops moving or spinning, a plurality of modifiers such as the multipliers of 2×, 4×, 10×, 2× and 5× are indicated on paylines 52b, 52c, 52a, 52d and 52e, respectively. In this example, the wild symbol 205 shown in FIG. 5A, changes or causes each of the displayed symbols on the inner reel to change to or functions as wild symbols. Therefore, all of the symbols on reel set 54a are wild symbols (or act as wild symbols) and provide the player with more opportunities to obtain awards in the game.

As illustrated in FIG. 5B, paylines 52a and 52b indicate winning symbol combinations in this play of the game. Specifically, payline 52a indicates a multiplier of 10×, a bar symbol 208c and a bar symbol 208d. Because the underlying symbol on the inner reel of reel set 54a is a wild symbol, payline 52a indicates a winning symbol combination including three bar symbols. The gaming device provides an award of one hundred to the player for the winning symbol combination and modifies or multiplies that award by ten because the multiplier of 10× which is also indicated by payline 52a. Therefore, the gaming device provides an award of one thousand to the player for the symbol combination indicated by payline 52a. Payline 52b indicates a multiplier of 2×, a cherry symbol 208a and a cherry symbol 208b. The wild symbol 205 changed the bell symbol which underlies the multiplier of 2× to a wild symbol or causes the bell symbol to act as a wild symbol. It should be appreciated that the wild symbol may change or cause the underlying symbol to act as a wild symbol or change or cause the multiplier to act as a wild symbol in a play of the game. In this example, the combination of the wild symbol (i.e., the bell symbol) with the two cherry symbols 208a and 208b provides a symbol combination including three cherry symbols. The gaming device provides an award of twenty-five to the player for the winning symbol combination including three cherry symbols. The award of twenty-five is multiplied by the multiplier of 2× labeled 206a which is also indicated by payline 52b. Therefore, the gaming device provides an award of fifty for the winning symbol combination indicated by payline 52b. On payline 52b, the wild symbol 205 enables the player to obtain an award where the player would not have received an award because payline 52b initially indicated a bell symbol and two cherry symbols, which does not form a winning symbol combination. Therefore, the player obtained two awards in this play of the game where the player would have obtained one award without the wild symbol 205. The award of fifty associated with payline 52b is added or summed with the award of one thousand associated with the winning symbol combination indicated by payline 52a to give the player a total award of one thousand fifty for this play of the game as indicated by the award display 210.

In an alternative embodiment, after the reel sets are activated as shown in FIG. 5B, the gaming device and more specifically, the processor, evaluates the symbols on each of the paylines at two different times. First, the processor evaluates the symbols indicated on each of the paylines before the wild symbol 205 changes one or more of the symbols on the inner reel to wild symbols (or causes the symbols on the inner reel to act as wild symbols). The processor then re-evaluates the symbols indicated on the paylines after the wild symbol 205 changes the symbols on the inner reel to wild symbols (or causes the symbols on the inner reel to act as wild symbols). For example in FIG. 5B, the processor evaluates the symbols on the reel sets without any of the symbols on the inner reel of reel set 54a being wild except for the wild symbol or trigger symbol 205. Payline 52a indicates a winning symbol combination including the wild symbol 205, the bar symbol 208c and the bar symbol 208d. The processor therefore provides an award of one hundred to the player. In this embodiment, any awards provided to the player after the first evaluation are not modified or multiplied by the multipliers indicated by the paylines. It should be appreciated that the awards may or may not be modified by the multipliers indicated by the paylines. In this example, none of the other paylines indicated a winning symbol combination.

The processor then causes each of the symbols on the inner reel of reel set 54a to be wild symbols or act as wild symbols. The processor re-evaluates the symbols on the reel sets. As illustrated in FIG. 5B, the symbols on the paylines now indicate two winning symbol combinations as described above. Payline 52a indicates a winning symbol combination including the wild symbol 205, the bar symbol 208c and the bar symbol 208d. Payline 52b indicates a bell symbol (i.e., a wild symbol), a cherry symbol 208a and a cherry symbol 208b. The gaming device provides awards of one hundred for the three bar symbols indicated on payline 52a and twenty-five for the three cherry symbols indicated on payline 52b. The award of one hundred is multiplied by the multiplier of 10× indicated by payline 52a to provide the player with an award of one thousand. The award of twenty-five is multiplied by the multiplier of 2× indicated by payline 52b to provide the player with an award of fifty. In the two evaluations of the symbols indicated by the reel sets, the processor provided the player with awards of one hundred, one thousand and twenty-five or a total award of one thousand one hundred and twenty-five in this play of the game. The dual evaluations of the reel sets therefore provides increased excitement and enjoyment for players because the players may obtain several awards or one or more very large awards in a play of the game.

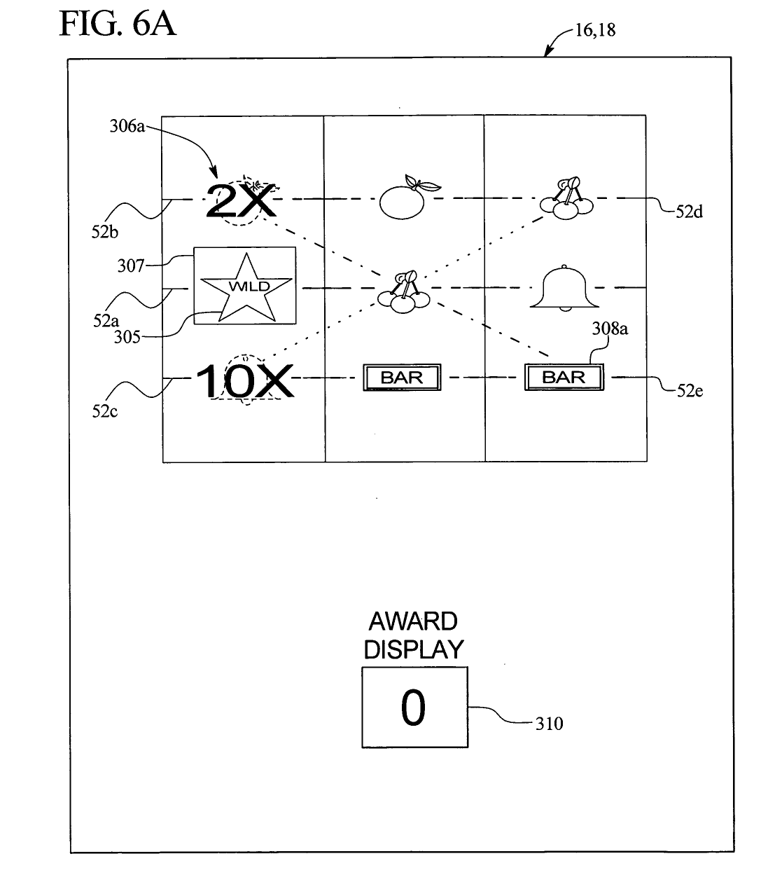

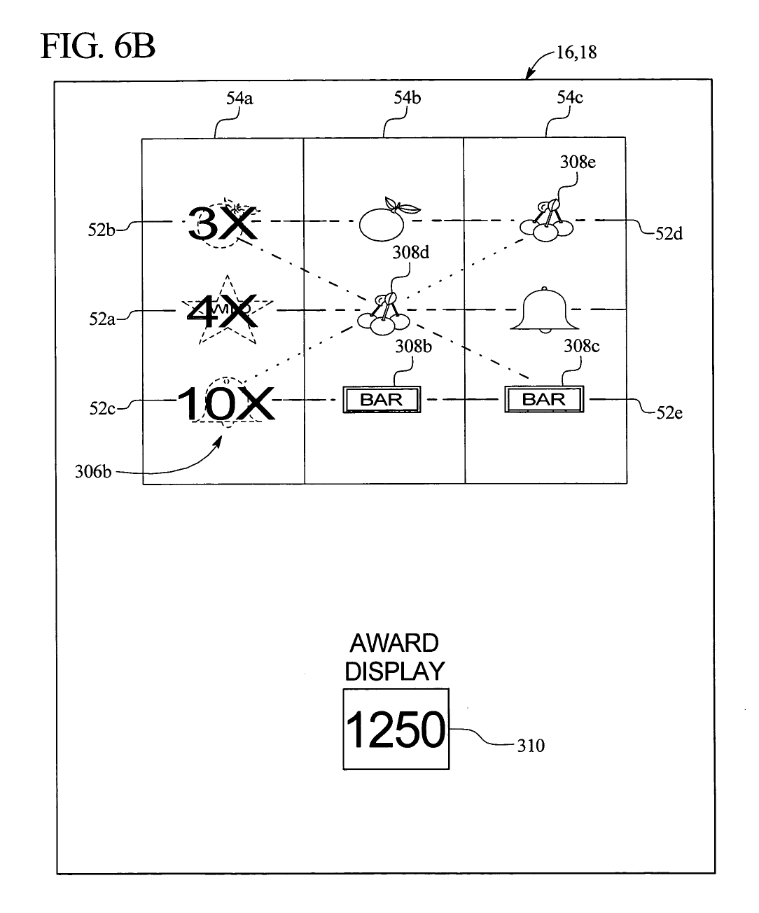

Referring now to FIGS. 6A and 6B, another embodiment of the present invention is illustrated where the viewable area 307 is sized and/or positioned to enable the player to view only one symbol (i.e., one symbol position) of the inner reel of the reels set 54a. The smaller viewable area or window size increases the difficultly of obtaining or indicating the wild symbol 305 on a payline in a play of the game. Therefore, the players excitement and enjoyment of the game increases because the probability of obtaining the designated symbol or wild symbol is lower and therefore provides more excitement when it is indicated in a play of the game.

In FIG. 6A, the gaming device or player activates the reel sets 54a, 54b and 54c to cause the reel sets 54b and 54c and the inner reel of reel set 54a to move or rotate. When the inner reel of reel set 54a and the reel sets 54b and 54c stop moving or spinning, a plurality of symbol combinations are indicated by paylines 52a, 52b and 52c associated with the reel sets. Specifically, the wild symbol 305 is indicated by payline 52a in the play of the game. Therefore, the wild symbol 305 causes each of the other symbols on the inner reel to be, act as or function as wild symbols as described above. Additionally, the wild symbol 305 causes the gaming device to move or rotate the outer reel of reel set 54a to display a plurality of modifiers such as the multipliers 306a to the player. In this embodiment, the gaming device does not re-activate or re-spin the reel sets 54b and 54c.

Referring now FIG. 6B, after the outer reel of 54a stops moving or spinning, multipliers of 3×, 4× and 10× are indicated by paylines 52a, 52b and 52c, respectively. The gaming device now evaluates the symbol combinations on each of these paylines to determine if any winning symbols combinations are indicated by these paylines. Payline 52c indicates a multiplier of 10×, a bar symbol 308b and a bar symbol 308c. Because the symbol underlying the multiplier of 10× functions as a wild symbol, the symbol combination indicated by payline 52c includes three bar symbols. A winning symbol combination including three bar symbols provides an award of one hundred to the player. The award of one hundred is multiplied by the multiplier on payline 52c, which is 10×, to provide an award of one thousand to the player. As shown in FIG. 6B, the player obtained a winning symbol combination including three bar symbols instead of a symbol combination including a bell symbol and two bar, symbols, which is not a winning symbol combination, because of the designated symbol or wild symbol 305.

Another winning symbol combination is indicated by payline 52d (which is the diagonal payline extending from the bottom symbol position of reel set 54a to the top symbol position of reel set 54c). This payline indicates a multiplier of 10×, a cherry symbol 308d and a cherry symbol 308e. Again, the first symbol underlying the multiplier of 10× is a wild symbol (i.e., the bell symbol converted or changed to a wild symbol). Therefore, payline 52d indicates a winning symbol combination including three cherry symbols, instead of a non-wining symbol combination including a bell symbol and two cherry symbols. The gaming device provides an award of twenty-five to the player for the winning symbol combination including the three cherry symbols. The award of twenty-five is multiplied by the multiplier of 10× to provide an award of two hundred fifty associated with the winning symbol combination indicated by payline 52d. The gaming device therefore provides a total award of one thousand two hundred fifty to the player in this play of the game as indicated by the award display 310 of FIG. 6B.

As shown in the example as illustrated by FIGS. 6A and 6B, the designated symbol or wild symbol enables a player to have an opportunity to obtain multiple awards in a play of a game associated with the different paylines associated with the reel sets. The players excitement and enjoyment of the game increases because the player has the opportunity to obtain more awards and possibly a very large award in the play of the game.

In another embodiment, the designated symbol or wild symbol may be indicated by any payline associated with any reel sets when the wild symbol is viewable or visible through the viewable area or window of the outer reel. In a further embodiment, the wild symbol must be indicated by a designated payline to change one or more of the other symbols into wild symbols in a play of the game. It should be appreciated that the wild symbol may be indicated by a designated payline, a plurality of designated paylines, one or more randomly determined paylines or any suitable payline associated with the reel sets in a game. It should also be appreciated that the reel sets including the concentric reels may include one wild symbol or a plurality of wild symbols.

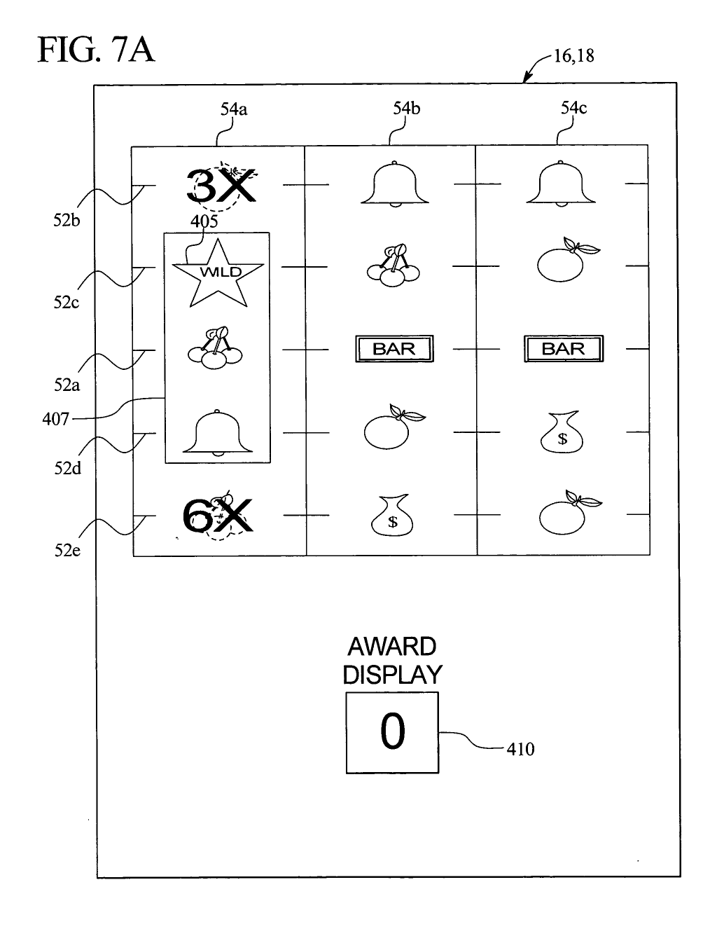

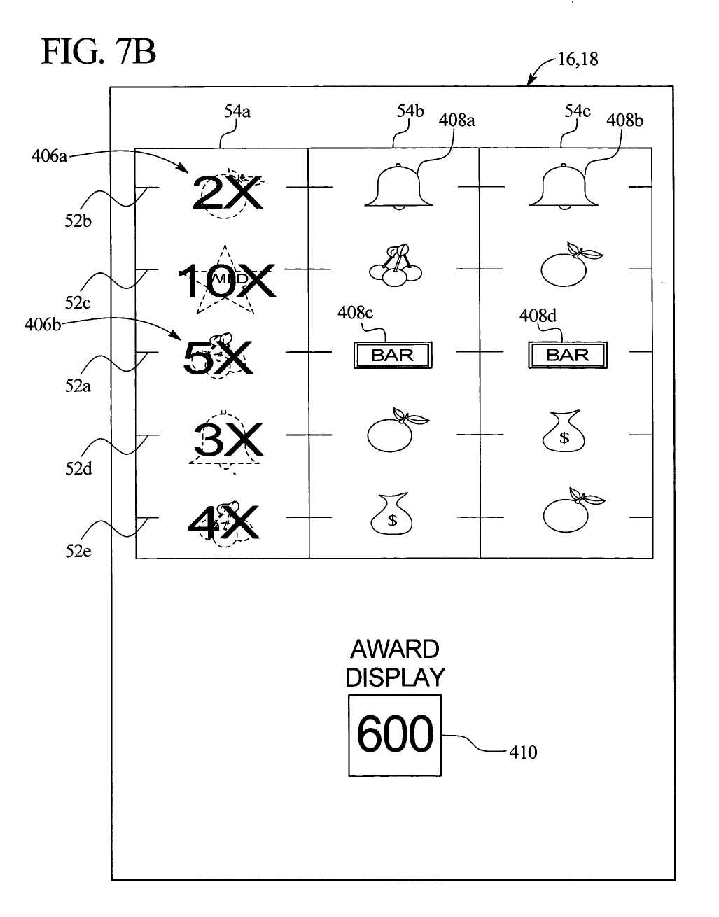

Referring now to FIGS. 7A and 7B, an example of an embodiment where the wild symbol is indicated by any payline associated with the reel sets is illustrated. As shown in FIG. 7A, the gaming activates the reel sets 54a, 54b and 54c in a play of the game. After the reel sets 54b, 54c and the inner reel of reel set 54a stop moving or spinning, the reel sets display a plurality of symbol combinations to the player. Specifically, the wild symbol 405 is viewable or visible through the viewable area or window 407 of reel set 54a. Although the wild symbol 405 is not indicated by payline 52a, the wild symbol 405 still causes the outer reel to move and also causes the other symbols of the inner reels of reel set 54a to be wild symbols in this play of the game. The gaming device therefore moves the outer reel of reel set 54a to indicate multipliers for each of the paylines associated with the reel sets 54a, 54b and 54c.

Referring now to FIG. 7B, the gaming device moves or rotates the outer reel of reel set of 54a to indicate multipliers of 2×, 10×, 5×, 3× and 4× associated with paylines 52b, 52c, 52a, 52d and 52e, respectively. In this example, the symbols of the inner reel underlying each of the multipliers on paylines 52b, 52c, 52a, 52d and 52e are wild symbols. As a result, paylines 52a and 52b indicate winning symbol combinations in this play of the game. In particular, payline 52a indicates a wild symbol, a bar symbol 408c and a bar symbol 408d. The winning symbol combination including three bar symbols provides an award of one hundred to the player. The award of one hundred is multiplied by the multiplier of 5× labeled 406b which is indicated by payline 52a. The gaming device therefore provides an award of five hundred associated with the winning symbol combination indicated by the payline 52a. Payline 52b also indicates a winning symbol combination including a wild symbol, a bell symbol 408a and a bell symbol 408b. A winning symbol combination including three bell symbols provides an award of fifty. The award of fifty is multiplied by the multiplier of 2× labeled 406a which is indicated by payline 52b. Therefore the gaming device provides an award of one hundred to the player for the winning symbol combination indicated by payline 52b. The awards of one hundred and five hundred are summed or added together to provide the player with a total award of six hundred in this play of the game as indicated by the award display 410. In this example, the gaming device provided two awards to the player for winning symbol combinations on the paylines where the initial symbol combinations did not provide an award to the player.

In one embodiment, one of the reel sets displayed by the gaming device includes the concentric reels described above having an inner reel and outer reel. In another embodiment, a plurality of the reel sets displayed by the gaming device include the concentric reels. In a further embodiment, all of the reel sets displayed by the gaming device include the concentric reels. It should be appreciated that any suitable number of the reel sets displayed by the gaming device may include the concentric reels described above.

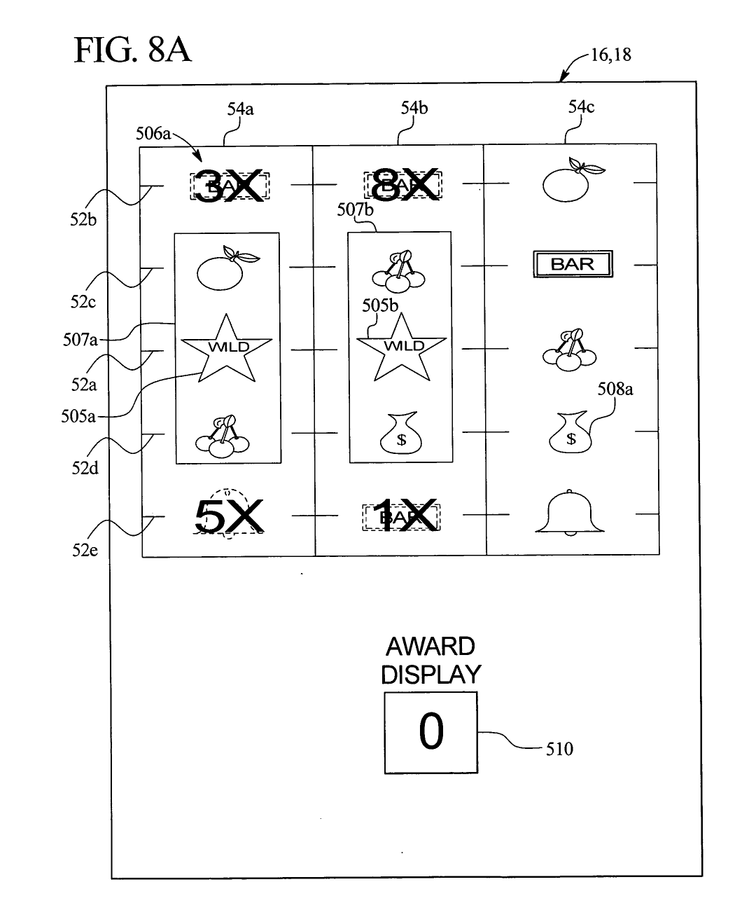

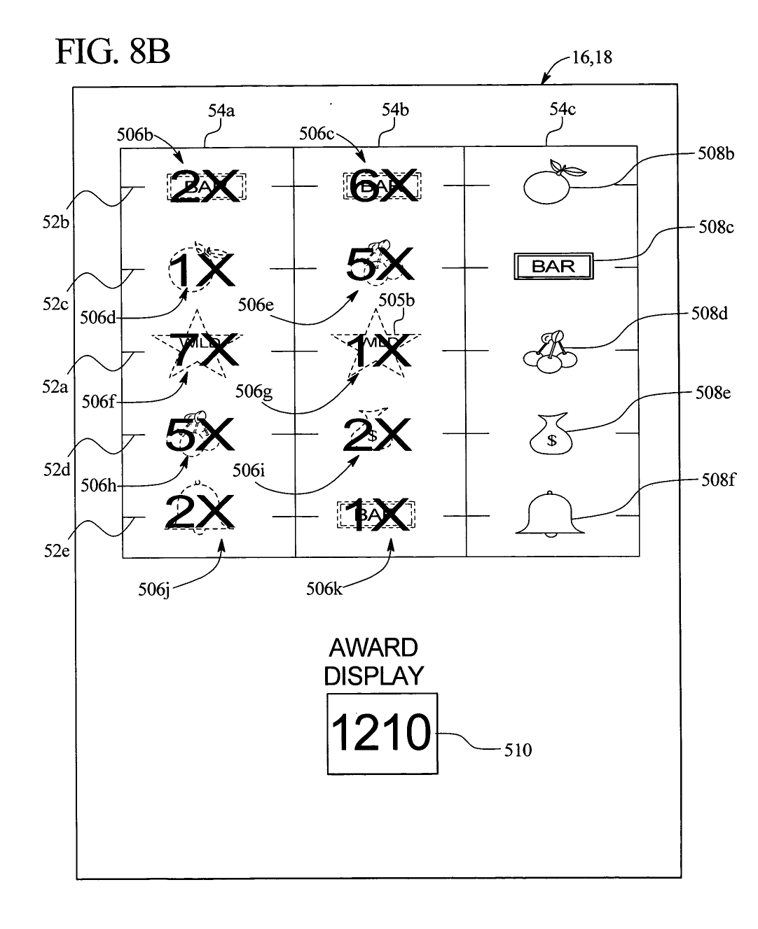

Referring now to FIGS. 8A and 8B, an example of the embodiment where a plurality of reel sets including the concentric reels is illustrated where reel sets 54a and 54b each include an inner reel having a plurality of symbols and a designated symbol or wild symbol and the outer reels include a plurality of multipliers. In a play of the game, the gaming device or player activates the reel sets 54a, 54b and 54c. When the inner reels of reel sets 54a and 54b and 54c stop moving or spinning, the gaming device determines whether the designated symbol or wild symbol is indicated or visible or viewable through the viewable areas 507a, 507b associated with reel sets 54a and 54b, respectively, in the play of the game. As illustrated in FIG. 8A, viewable areas 507a and 507b each indicate the wild symbol 505a and 505b, respectively. Therefore, each of the symbols on the inner reels associated with reel sets 54a and 54b are changed to, act as or function as wild symbols. The gaming device will now move or rotate the outer reels of reel sets 54a and 54b to indicate multipliers for each payline associated with the reel sets.

Referring to FIG. 8B, after the outer reels of reel sets 54a and 54b stop moving or rotating, a plurality of multipliers are indicated by the paylines 52a, 52b, 52c, 52d and 52e associated with each of the reel sets. Specifically, the outer reel of reel set 54a indicates multipliers of 2×, 1×, 7×, 5× and 2× associated with paylines 52b, 52c, 52a, 52d, and 52e, respectively. Multipliers of 6×, 5×, 1×, 2× and 4× indicated by the outer reel set 54b are associated with paylines 52b, 52c, 52a, 52d and 52e, respectively. Reel set 54c does not include the concentric reels and therefore displays a plurality of conventional symbols such as an orange symbol 508b, a bar symbol 508c, a cherry symbol 508d, a money bag symbol 508e and a bell symbol 508f. The gaming device now evaluates each of the symbol combinations indicated by the paylines associated with the reel sets to determine if any winning symbol combinations are indicates by the paylines. In this embodiment, because reel sets 54a and 54b each indicate a wild symbol, and therefore change each of the symbols associated with these reel sets into wild symbols, each payline associated with the reel sets indicates a winning symbol combination in the play of the game.

Payline 52a indicates a wild symbol, a wild symbol and a cherry symbol 508d. A winning symbol combination including three cherry symbols provides an award of twenty-five. The award twenty five is multiplied by the sum of the multipliers indicated by payline 52a, which is 8× (i.e., 7× and 1×). Therefore the gaming device provides an award of two hundred to the player for the winning symbol combination indicated by payline 52a. Payline 52b indicates a wild symbol, a wild symbol and an orange symbol 508b. A winning symbol combination including three orange symbols provides an award of five. The award of five is multiplied by the sum of the multipliers of 2× and 6×, which is 8×, to provide an award of forty associated with the winning symbol combination indicated by payline 52b. Payline 52c indicates a wild symbol, a wild symbol and a bar symbol 508c. A winning symbol combination including three bar symbols provides an award of one hundred. The award of one hundred is multiplied by the sum of the multipliers 1× and 5×, which is 6×, to provide an award of six hundred to the player for the winning symbol combination indicated by payline 52c. Payline 52d indicates a wild symbol, a wild symbol and a money bag symbol 508e. A winning symbol combination including three money bags symbols provides an award of ten. An award of ten is multiplied by the sum of the multipliers of 5× and 2×, which is 7×, to provide an award of seventy associated with the winning symbol combination indicated by payline 52d. Payline 52e indicates a wild symbol, a wild symbol and a bell symbol 508f. A winning symbol combination including three bell symbols provides an award of fifty. The award of fifty is multiplied by the sum of the multipliers of 2× and 4×, which is 6×, to provide an award of three hundred associated with the winning symbol combination indicated by payline 52e. The gaming device sums all of the awards together to provide a total award of one thousand two hundred ten to the player as indicated by the award display 510.

Again, as illustrated in FIGS. 8A and 8B, the player received a plurality of awards in the game for winning symbol combinations including the changed or converted wild symbols where the player would not have received any awards based on the initial symbol combinations indicated on the reel sets. Accordingly, the players excitement and enjoyment increases when a plurality of the reel sets include the concentric reels. More specifically, the players excitement and enjoyment increases when a plurality of the reel sets indicate or have the potential to indicate a plurality of wild symbols in a play of the game because a player has a greater opportunity to obtain a number of awards in a play of the game and possibly a very large award in the play of the game. It should be appreciated that one, plurality of all of the reel sets in the game may include the concentric reels described above.

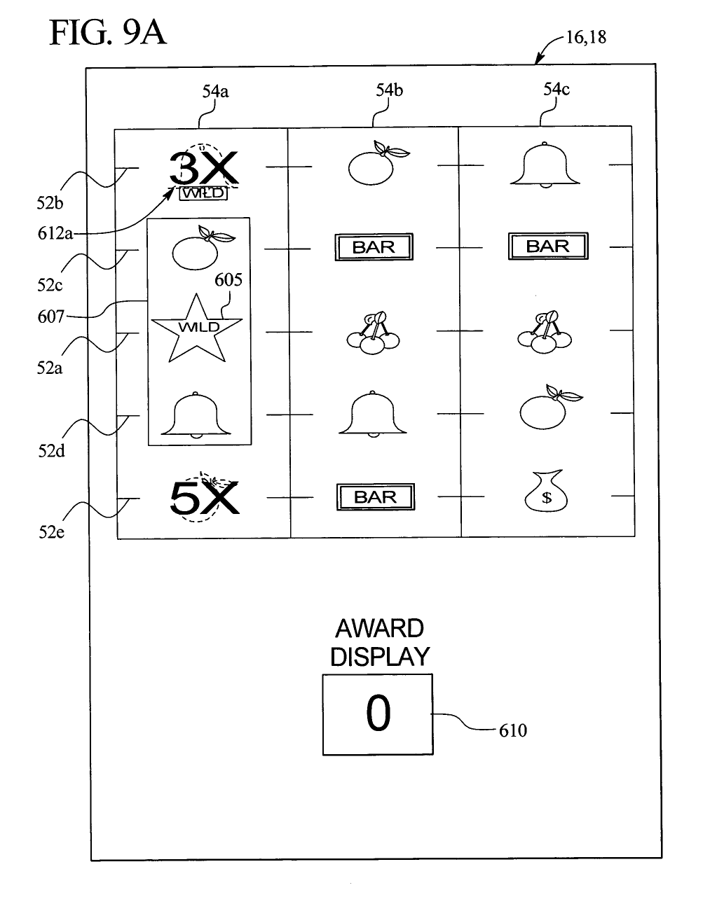

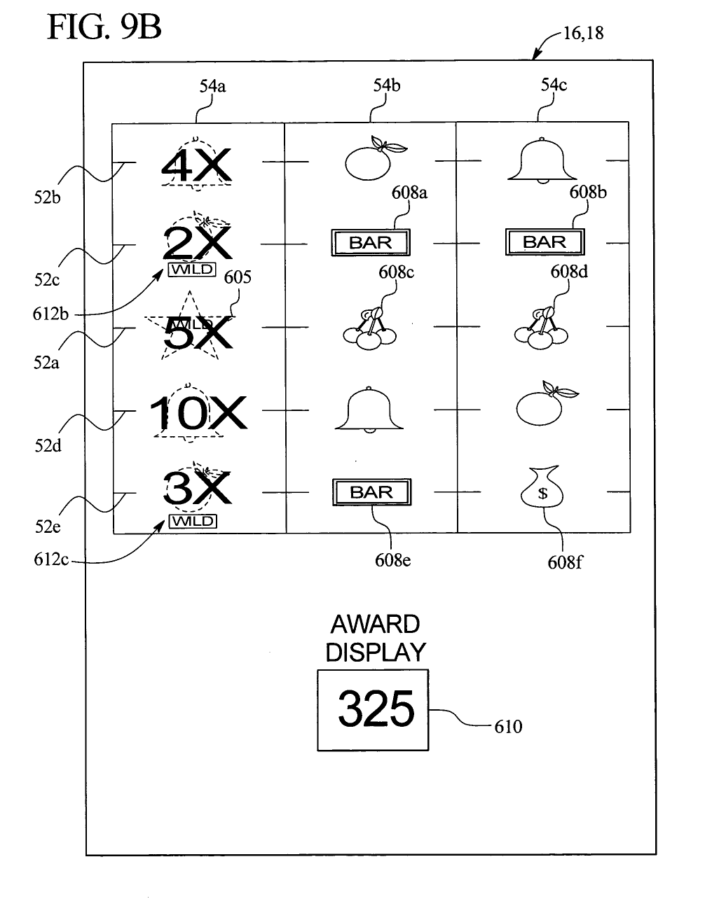

Referring now to FIGS. 9A and 9B, another embodiment of the present invention is illustrated where one or more of the modifiers displayed by the outer reel include or are associated with wild symbols. For example, multiplier 612a acts as or functions as a wild symbol or is associated with a wild symbol as indicated by the term “WILD” positioned adjacent to the multiplier. In this embodiment, the designated symbol or wild symbol does not cause one or more of the other symbols of the inner reel to become wild symbols. Instead only the modifiers which are wild or associated with the wild symbols act as or function as wild symbols in the play of the game. In one embodiment, the wild symbol also acts as a wild symbol in the play of the game. In another embodiment, the wild symbol does not act as a wild symbol in the game but still acts as a trigger to cause the outer reel to move or rotate to indicate a plurality of the modifiers of the outer reel in the play of the game. It should be appreciated that one, a plurality of all of the modifiers displayed by the outer reel of each reel set including the concentric reels may be wild, associated with wild symbols, act as or function as wild symbols in a game. It should also be appreciated that the modifiers (which are wild symbols) may be randomly determined, predetermined or determined according to any suitable determination method.

In FIG. 9A, an example of the above embodiment is illustrated where three reel sets 54a, 54b and 54c are displayed to the player in a play of the game. Reel set 54a includes the concentric reels described above where one or more of the modifiers are wild symbols or act as wild symbols in the play of the game. The wild symbol 605 causes the outer reel to move when the wild symbol is indicated on one of the paylines and is visible through the viewable areas or windows 607 in a play of the game. The other reel sets 54b and 54c indicate conventional symbols as shown in FIG. 9A. In the example shown in FIG. 9A, the gaming device or player activates the reel sets 54a, 54b and 54c in a play of the game. When the reel sets 54b and 54c and the inner reel of reel set 54a stop moving or spinning, a plurality of symbol combinations are indicated by the reel sets. Specifically, wild symbol 605 is visible or viewable through the viewable area or window 607 and is indicated by payline 52a in the play of the game. Therefore, the gaming device will move or rotate the outer reel of reel set 54a to indicate modifiers on each of the paylines.

Referring now to FIG. 9B, a plurality of modifiers such as the multipliers 4×, 2×, 5×, 10× and 3× are associated with paylines 52b, 52c, 52a, 52d and 52e, respectively are indicated by reel set 54a. The modifiers or multipliers 612b and 612c are wild and therefore act as or function as wild symbols as shown in FIG. 9B. The gaming device now evaluates the symbol combinations indicated by each of the paylines. Payline 52c indicates a wild symbol, a bar symbol 608a and a bar symbol 608b. Therefore, payline 52c indicates a winning symbol combination including three bar symbols. The winning symbol combination including three bar symbols provides an award of one hundred to the player. The award of one hundred is multiplied by the multiplier of 2× indicated by payline 52c to provide an award of two hundred associated with the symbol combination indicated by payline 52c. Payline 52a also indicates a winning symbol combination including a wild symbol 605, a cherry symbol 608c and a cherry symbol 608d. The winning symbol combination including three cherry symbols provides an award of twenty-five to the player. The award of twenty-five is multiplied by the multiplier of 5× indicated by payline 52a to provide an award of one hundred twenty-five associated with the winning symbol combination indicated by payline 52a. None of the other paylines indicate winning symbol combinations in this play of the game. Therefore, the awards of two hundred and one hundred twenty-five are summed to provide a total award of three hundred twenty-five to the player as indicated by the award display 610. As shown in FIG. 9B, the multiplier 612c is a wild symbol but did not combine with the other symbols indicated by payline 52e to provide a winning symbol combination in the game. Therefore, associating wild symbols with one or more of the modifiers in a play of the game provides the player with an opportunity to obtain more awards in a play of the game and potentially a very large award in the game, which increases the players excitement and enjoyment of the game.

It should be appreciated that one, a plurality or all of the modifiers associated with each of the reel sets including the concentric reels described above may be wild symbols, associated with wild symbols or act as wild symbols in a game. It should also be appreciated that the number of modifiers which are wild symbols or act as wild symbols may be randomly determined, predetermined or determined according to any suitable determination method.

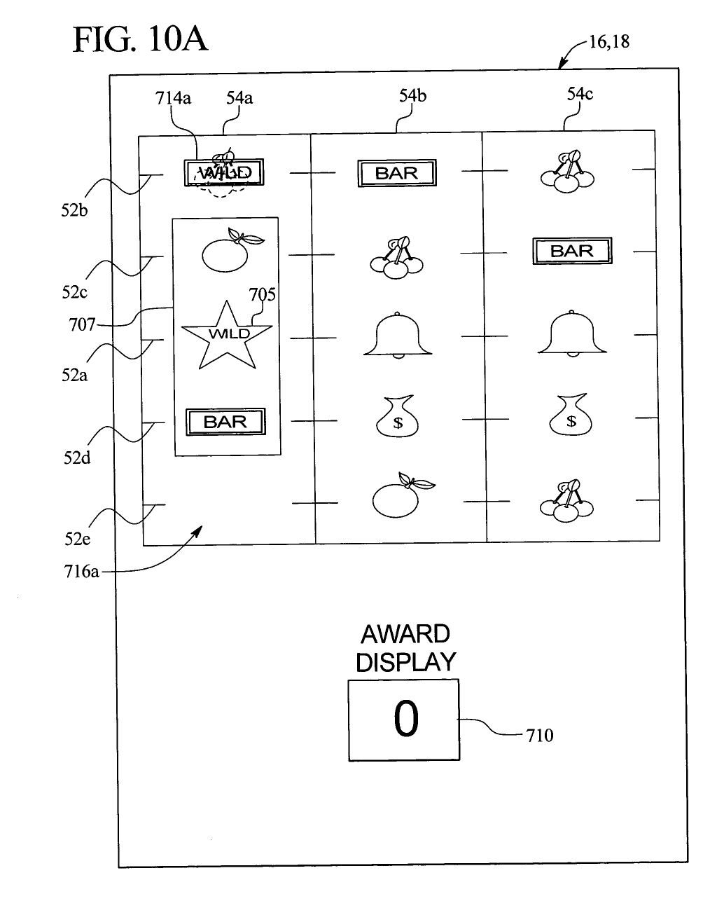

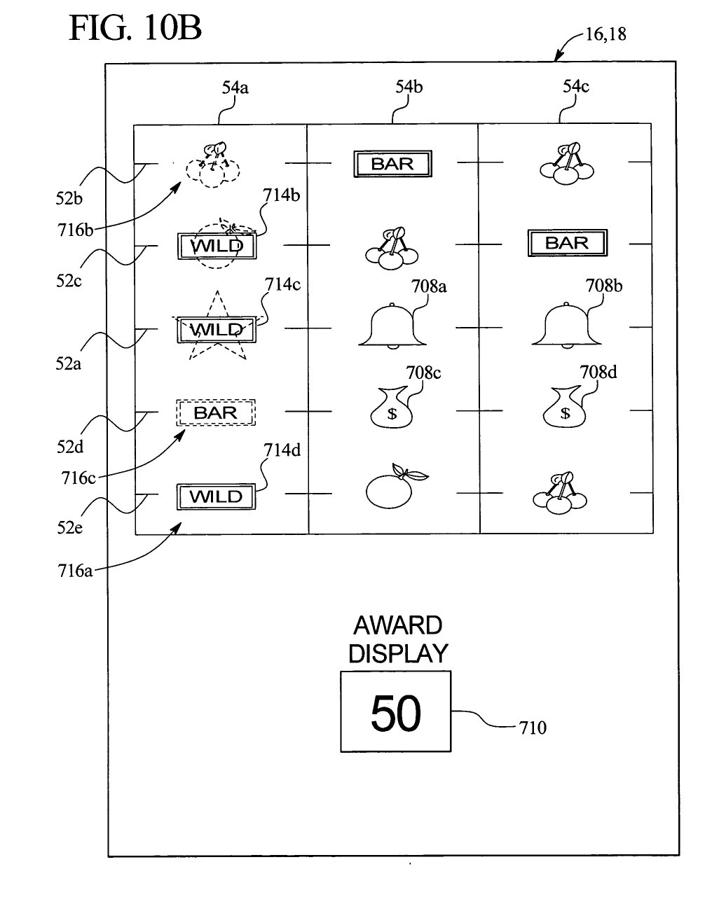

Referring now to FIGS. 10A and 10B, a further embodiment of the present invention is illustrated where the inner reel includes a plurality of symbols or first symbols including a designated symbol or wild symbol and the outer reel includes one or more separate wild symbols. In one embodiment, the outer reel also includes one or more empty spaces or blanks symbols 716a. It should be appreciated that the outer reel may include one or a plurality of blanks symbols and also may include one or a plurality of separate wild symbols.

Referring to FIG. 10A, an example of this embodiment is illustrated where the gaming device includes a plurality of reel sets 54a, 54b and 54c where reel set 54a includes the concentric reels described above. Reel set 54a includes an inner reel and an outer reel where the inner reel includes a plurality of conventional symbols such as an orange symbol and a bar symbol, and at least one wild symbol 705. The outer reel includes at least one blank symbol 716a and at least one wild symbol 714a. Reel sets 54b and 54c include a plurality of conventional symbols such as a bar symbol, a cherry symbol, a bell symbol, a money bag symbol and an orange symbol. Also, a plurality of paylines 52a, 52b, 52c, 52d and 52e are associated with the reel sets 54a, 54b and 54c.

In a play of the game, the gaming device or player activates the reel sets 54a, 54b and 54c to cause the reel sets to indicate a plurality of symbols in the play of the game. When the reel sets and the inner reel set of 54a stop spinning, the wild symbol 705 is visible or viewable through the viewable area or window 707 on reel set 54a. Therefore, the gaming device causes the outer reel of reel set 54a to move or rotate to indicate one or more wild symbols and/or blank symbols to a player.

Referring to FIG. 10B, after the outer reel of reel set 54a is moved or rotated, the outer reel of reel set 54a indicates a blank symbol 716b on payline 52b, a wild symbol 714b on payline 52c, a wild symbol 714c on payline 52a, a blank symbol 716c on payline 62d and a wild symbol 714d on payline 52e. The gaming device now evaluates the symbol combinations indicated by the paylines to determine if any winnings symbol combinations are indicated by the paylines. As shown in FIG. 10B, payline 52a indicates a winning symbol combination including a wild symbol 714c, a bell symbol 708a and a bell symbol 708b. A winning symbol combination including three bell symbols provides an award of fifty to the player as indicated by the award display 710. As shown in FIG. 10B, payline 52d almost provided a winning symbol combination to the player. Specifically, 52d indicates a bar symbol 716c, a money bag symbol 708c and a money bag symbol 708d. Because only two money bag symbols are indicated by payline 52d, the gaming device did not provide an award to the player. However, if one of the wild symbols such as wild symbol 714c was indicated on payline 52d, the player would of obtained an award for a winning symbol combination including three money bag symbols. Therefore, the present embodiment provides excitement and enjoyment for players because a player may or may not obtain a winning symbol combination in a play of the game depending on the number and location of the wild symbols indicated on the paylines in the play of the game.

In another embodiment, the concentric reels described above include an inner reel having a plurality of first symbols and an outer reel defining at least one viewable area and including at least one of the first symbols of the inner reel. It should be appreciated that the first symbols on the outer reel may be any suitable symbol or symbols. In this embodiment, the outer reel of the reel sets including the concentric reels is moved or rotated when the designated symbol is indicated or viewable through the viewable area or window of the outer reel. After the outer reel moves or rotates, one or more of the first symbols on the outer reel are displayed or indicated on the paylines associated with the reel sets. The gaming device or processor evaluates the symbol combinations indicated by the paylines including the symbols on the outer reel and provides an outcome such as an award to the player for any winning symbol combinations indicated by the paylines.

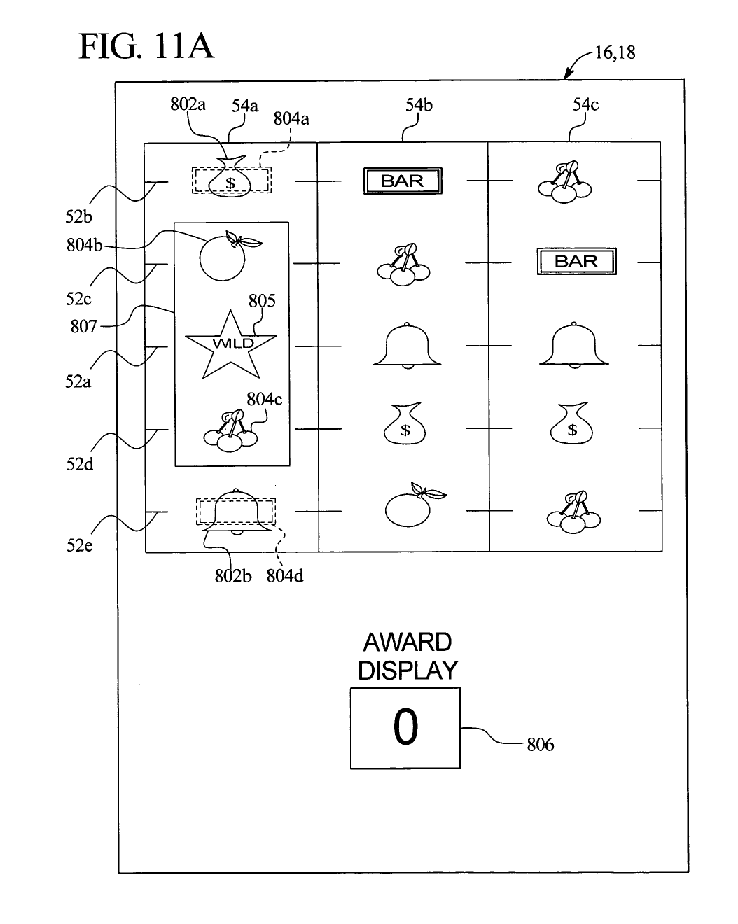

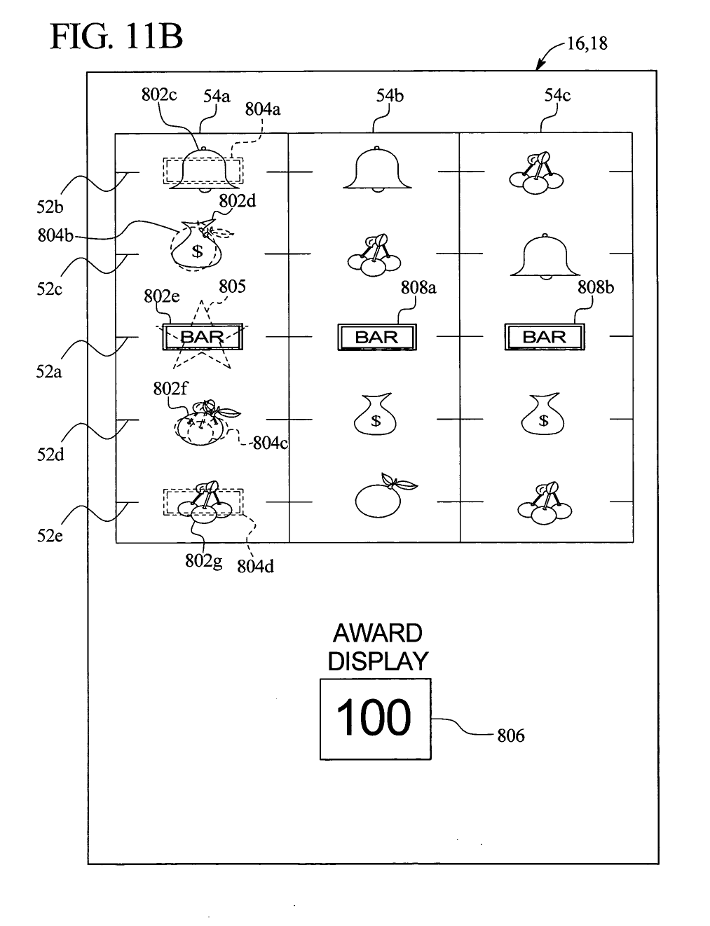

Referring now to FIGS. 11A and 11B, an example of the above embodiment is illustrated where the gaming device includes a plurality of reel sets 54a, 54b and 54c where one of the reel sets 54a includes the concentric reels described above. Specifically, reel set 54a includes an inner reel having a plurality of first symbols such as the bar symbol 804a, the orange symbol 804b, the wild symbol 805, the cherry 804c and the bar symbol 804d. The outer reel defines at least one viewable area or window 807 which is held stationary or fixed in place until the designated symbol 805 is indicated or viewable through the viewable area. The outer reel also includes a plurality of the first symbols, such as the money bag symbol 802a and the bell symbol 802b. The outer reel sets 54b and 54c include a plurality of the first symbols as illustrated by FIG. 11A. An award display 806 indicates the outcome or award provided to the player in a play of the game.

In a play of the game, the gaming device or processor activates the reel sets 54a, 54b and 54c to display a plurality of symbols to player. As shown in FIG. 11A, the designated symbol or wild symbol 805 is indicated or viewable through the viewable area 807 in the play of the game. The gaming device or processor therefore causes the outer reel to move or rotate to display or indicate a plurality of the symbols on the outer reel.

Referring to FIG. 11B, after the outer reel moves or rotates, a plurality of the symbols such as the bell symbol 802c, the money bag symbol 802d, the bar symbol 802e, the orange symbol 802f and the cherry symbol 802g are displayed to a player and indicated by the paylines associated with the reel sets. The gaming device or processor evaluates the symbol combinations indicated by the paylines and specifically evaluates the symbols on the outer reel of reel set 54a and the symbols on reels sets 54b and 54c. In this example, payline 52 indicates a bar symbol 802e, a bar symbol 808a and a bar symbol 808b, which is a winning symbol combination. No other winning symbol combinations are indicated by the paylines. The gaming device therefore provides an outcome such as an award to the player for the winning symbol combination including three bar symbols. A winning symbol combination including three bar symbols provides an award of one hundred to the player as indicated by the award display 806.

In another embodiment, the gaming device evaluates the symbol combinations indicated by the paylines 52 associated with the reel sets 54 a plurality of times in a play of the game. For example, in FIG. 11B, the gaming device evaluates the first symbols 804a, 804b, 805, 804c, and 804d on the inner reel of reel set 54a and the symbols indicated by the reel sets 54b and 54c. Accordingly, payline 52a indicates a winning symbol combination including designated symbol or wild symbol 805, the bar symbol 808a and the bar symbol 808b. This is a winning symbol combination including three bar symbols which provides an award of one hundred as described above. The gaming device re-evaluates the symbols indicated by the reel sets based on the symbols indicated on the outer reel of reel set 54a. As described above, payline 52 indicates a winning symbol combination including three bar symbols 802, 808a and 808b. The winning symbol combination including three bar symbols provides an award of one hundred. Therefore, the gaming device provides an award of two hundred to the player in this play of the game.

As another example, the gaming device or processor evaluates the symbols indicated by the reel sets before the designated symbol changes one or more of the first symbols on the inner reel to a wild symbol as described above and after the designated symbol changes one or more of the first symbols on the inner reel to wild symbols in a play of the game. It should be appreciated that the gaming device or processor evaluates the symbol combinations indicated on the paylines at any point or points in a play of the game. This embodiment increases the excitement and enjoyment for a player because the player has multiple opportunities to obtain an outcome such as an award or awards in a play of the game.

In an further embodiment, the gaming device holds the outer reel stationary or fixed in place while the inner reel moves or rotates after the activation of the reel sets in a play of the game. In this embodiment, the gaming device or processor holds the outer reel stationary or fixed for a designated number of plays of the game or for a designated number of activations of the reel sets. For example, the gaming device or processor holds the outer reel stationary for five plays of the game or five activations of the reel sets. Therefore, if the designated symbol is not indicated or viewable through the viewable area or window of the outer reel in the first five activations of the reel sets, the gaming device or processor causes the outer reel to move or rotate automatically in the fifth play of the game or fifth activation of the reel sets. It should be appreciated that the designated number of plays of the game and the designated number of activations of the reel sets may be randomly determined, predetermined or determined in any suitable manner in a play of the game.

In one alternative embodiment, the concentric reels described above include an inner reel having a plurality of symbols and an outer reel defining at least one viewable area where the activation or movement of the outer reel is randomly determined by the gaming device. Therefore, the gaming device may randomly determine to move or rotate the outer reel regardless of whether a designated symbol or wild symbol is viewable or visible through an indicated viewable area or window. The gaming device may randomly determine to move or rotate the outer reel in one play of the game, in a plurality of plays of the game or in all of the plays of the game.

In another alternative embodiment, the gaming device includes a plurality of reel sets where a plurality of the reel sets include the concentric reels described above. In this embodiment, the gaming device randomly determines to move or activate the outer reels of each of the reel sets including the concentric reels in one or more of the plays of the game. The gaming device may activate or move the outer reel of one or more of the reel sets including the concentric reels sequentially or simultaneously in one or more plays of the game. It should be appreciated that the reel sets including the concentric reels may be moved or rotated in any suitable direction or in any suitable order.

In another alternative embodiment of the present invention, the gaming device enables the player to place an extra or additional wager to activate one or more of the outer reels of the reel sets including the concentric reels in game. For example, in a gaming device including three reel sets where one of the reels sets includes the concentric reel described above, the gaming device enables the player to place or make an additional wager in the game to cause the outer reel to move or rotate when the wild symbol is viewable or visible through an indicated viewable area in the play of the game. Therefore, if the wild symbol is indicated or viewable in the play of the game, and the player initially made or placed the additional wager, the gaming device causes the outer reel to move or rotate in that play of the game. If the player however, does not choose to make or place the additional wager in the game, the gaming device does not move or rotate the outer reel in that play of the game.

In a further alternative embodiment, in a gaming device including a plurality of reel sets, the gaming device enables the player to make an additional wager on one, a plurality or all of the reel sets including the concentric reels, to cause the gaming device to move or rotate the outer reels of those reel sets. For example, in a gaming device including three reel sets having the concentric reels, the gaming device enables the player to make an additional wager on each of the reel sets to cause the gaming device to activate the outer reel of each of the reel sets. For instance, the gaming device enables the player to make an additional wager of one credit to activate the outer reel of the first reel set, two credits to activate the outer reel of the first and second reel sets and three credits to activate all of the outer reels of the reel sets in a play of the game. It should be appreciated that the wager amount may be any suitable wager amount and may be the same for all the reels sets including the concentric reels or a different wager for one or more of the reel sets.

In another alternative embodiment, the gaming device includes a plurality of reel sets where at least one of the reel sets includes the concentric inner and outer reels and where the outer reel includes at least one modifier such as a multiplier. In this embodiment, the gaming device enables the player to make an additional or extra wager in one or more plays of the game to activate the designated symbol (i.e., activate the trigger feature associated with the designated symbol which causes the outer reel to move or rotate to display the modifier to the player). For example, in a gaming device including three reel sets having the concentric reels where the outer reel of each reel set includes at least one modifier, the gaming device enables the player to make an additional wager on each of the reel sets to cause the gaming device to activate the designated symbol or symbols on the outer reel in each of the reel sets. For instance, the player places or makes an additional wager of one credit to activate the designated symbol on the inner reel of the first reel set, two credits to activate the designated symbol on the inner reel of the first and second reel sets and three credits to activate the designated symbol on the inner reel of all of the reel sets in a play of the game. Thus, if the player wagers one credit, the gaming device activates the designated symbol (i.e., the trigger feature associated with the designated symbol) of the first reel set to display one or more modifiers on the outer reel of the first reel set when the designated symbol or wild symbol is viewable through the viewable area of the outer reel in a play of the game. When the player wagers two additional credits, the gaming device activates the designated symbol on the inner reel of the first and second reel sets to display one or more modifiers on the outer reel of these reel sets when the designated symbol or wild symbol is viewable through the viewable area of the outer reels of these reel sets. When the player wagers three credits, the gaming device activates the designated symbol on the inner reel of all of the reel sets to display one or more modifiers on the outer reels of these reel sets when the wild symbol is viewable through the viewable area of the outer reels of the reel sets. If the player does not make the additional wager on any of the reel sets, the designated symbol is not activated and therefore the outer reel of each of the reel sets does not move or rotate when the wild symbol is viewable through the viewable areas of the outer reels of the reels sets. As a result, the modifier or modifiers on the outer reels of the reel sets are not displayed and applied to any outcomes or awards provided to the player in that play of the game. It should be appreciated that the wager amount may be any suitable wager amount and may be the same for all the reels sets including the concentric reels or a different wager for one or more of the reel sets.

In a further alternative embodiment, the gaming device enables a player to place an additional wager on one or more of the reel sets including the concentric reels described above, to include or display one or more modifiers such as multipliers on the outer reels of the reel sets. For example, in a gaming device including three reel sets including concentric reels, the gaming device enables the player to wager one additional credit to display one or more modifiers on the outer reel of the first reel set, two credits to display one or more modifiers on the outer reel of the first and second reel sets and three credits to display one or more modifiers on the outer reel of all of the reel sets. Therefore, if the player does not make an additional wager, the outer reels of the reel sets do not include modifiers or multipliers. In this embodiment, the additional wager enables the player to obtain modifiers on one or more of the reel sets including the concentric reels. This increases a player's excitement and enjoyment of the game because the player has the opportunity to obtain larger awards in the game.

In another alternative embodiment, the gaming device enables a player to place an additional wager on one or more of the reel sets including the concentric reels to activate one or more modifiers included on the outer reels of the reel sets. For example, in a game including three reel sets including the concentric reels described above, where the outer reel of each of the reel sets includes at least one modifier, the gaming device enables the player to wager one additional credit to activate the modifiers on the outer reel of the first reel set. Accordingly, when the wild symbol is indicated by the viewable area of the outer reel of the first reel set, the gaming device moves the outer reel to display the modifiers on the outer reel to the player. Because the player placed the additional wager of one credit, each of the modifiers displayed by the outer reel of the first reel set are activated and modify the outcomes such as awards associated with winning symbol combinations indicated by the reel sets. In this example, the player wagers two credits to activate the modifiers on the outer reel of the first and second reel set and three credits to activate the modifiers on the outer reel of all of the reel sets. It should be appreciated that any suitable wager may be made to activate the modifiers on one or more of the reel sets. It should also be appreciated that the additional wager may activate one, a plurality or all of the modifiers on one, a plurality or all of the reel sets including the concentric reels described above.

In another alternative embodiment, the designated symbol or wild symbol acts as or functions as a wild symbol in a play of the game and substitutes for one or a plurality of the symbols indicated by the reel sets. In another embodiment, the designated symbol or wild symbol changes one or a plurality of the symbols on at least one of the outer reel and the other reel sets in a play of the game. It should be appreciated that the designated symbol or wild symbol may cause or change one or a plurality of the symbols on the outer reel and the other reel sets to be or act as a wild symbol in a play of the game.

In a further alternative embodiment, the gaming device includes at least one reel set including an inner reel and outer reel, where the outer reel includes at least one wild symbol that moves to one or more of the symbol positions on at least one of the inner reel, outer reel or other reel sets in a play of the game. In one embodiment, the designated symbol is the wild symbol. In another embodiment, the designated symbol or at least one of the other symbol on the outer reel include the wild symbol. It should be appreciated that the wild symbol on the outer reel may move to one or more of the symbol positions of the inner reel, outer reel and other reel sets in a play of the game. The wild symbol moves to one or more of the symbol positions and acts as or functions as a wild symbol in that play of the game.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A gaming device controlled by a processor, said gaming device comprising:
at least one first reel set including an inner reel and an outer reel, said inner reel including a plurality of first symbols, said first symbols including at least one designated symbol, said outer reel including a plurality of second symbols and defining at least one viewable area, said outer reel positioned to enable a player to view at least one of the first symbols on the inner reel; and
at least one second reel set including a plurality of the first symbols;
wherein the processor is operable to cause the inner reel of said first reel set to generate at least one of the first symbols, cause the second reel set to generate at least one of the first symbols and determine if the designated symbol is indicated by the viewable area defined by the outer reel of said first reel set,
wherein if the designated symbol is indicated by the viewable area:
(i) cause the outer reel to move and indicate at least one of the second symbols,
(ii) evaluate the second symbols indicated by the outer reel of the first reel set and the first symbols indicated by the second reel set, and provide an outcome based on the indicated first and second symbols; and
wherein if the designated symbol is not indicated by the viewable area:
(iv) evaluate the first symbols indicated by the viewable area of the first reel set and the first symbols indicated by the second reel set, and
(v) provide an outcome based on the indicated first symbols.

2. The gaming device of claim 1, wherein the designated symbol includes a wild symbol.

3. The gaming device of claim 1, wherein a plurality of the first symbols on the inner reel include designated symbols.

4. The gaming device of claim 3, wherein at least one of the designated symbols includes a wild symbol.

5. The gaming device of claim 1, wherein the designated symbol causes the processor to change at least one of the first symbols on the inner reel to a wild symbol if the designated symbol is indicated by the viewable area on the outer reel.

6. The gaming device of claim 1, wherein the designated symbol causes the processor to change a plurality of the first symbols on the inner reel to wild symbols if the designated symbol is indicated by the viewable area on the outer reel.

7. The gaming device of claim 1, wherein the designated symbol causes the processor to change all of the first symbols on the inner reel to wild symbols if the designated symbol is indicated by the viewable area on the outer reel.

8. The gaming device of claim 1, wherein at least one of the second symbols on the outer reel of the first reel set includes a modifier.

9. The gaming device of claim 8, wherein said modifier includes a wild symbol.

10. The gaming device of claim 1, wherein a plurality of the second symbols on the outer reel of the first reel set include a modifier.

11. The gaming device of claim 10, wherein at least one of said modifiers includes a wild symbol.

12. The gaming device of claim 1, wherein all of the second symbols on the outer reel of the first reel set include modifiers.

13. The gaming device of claim 12, wherein at least one of said modifiers includes a wild symbol.

14. The gaming device of claim 1, which includes at least one payline associated with the first and second reel sets.

15. The gaming device of claim 14, wherein the outcome is based on at least one of the first and second symbols indicated by the payline.

16. The gaming device of claim 1, which includes a plurality of paylines associated with the first and second reel sets.

17. The gaming device of claim 16, wherein the outcome is based on at least one of the first and second symbols indicated by one of the paylines.

18. The gaming device of claim 1, wherein the second reel set includes the inner reel and the outer reel.

19. The gaming device of claim 1, wherein the outer reel of the first reel set is substantially transparent.

20. The gaming device of claim 1, wherein at least one of the first and second symbols are the same.

21. The gaming device of claim 1, wherein a plurality of the first and second symbols are the same.

22. The gaming device of claim 1, wherein all of the first and second symbols are the same.

23. The gaming device of claim 1, wherein the processor is operable to hold the outer reel of the first reel set stationary to enable the player to view at least one of the first symbols on the inner reel until the designated symbol is indicated by the viewable area.

24. The gaming device of claim 23, wherein the processor is operable to hold the outer reel of the first reel set stationary for a designated number of activations of the reel sets.

25. The gaming device of claim 23, wherein the processor is operable to hold the outer reel of the first reel set stationary for a randomly determined number of activations of the reel sets.

26. A gaming device controlled by a processor, said gaming device comprising:
at least one first reel set including an inner reel and an outer reel, said inner reel including a plurality of first symbols, said first symbols including at least one designated symbol, said outer reel including a plurality of second symbols, at least one of said second symbols including a wild symbol, said outer reel defining at least one viewable area which is positioned to enable a player to view at least one of the first symbols on the inner reel; and
at least one second reel set including a plurality of the first symbols,
wherein the processor is operable to cause the inner reel to generate a plurality of the first symbols, cause the second reel set to generate a plurality of the first symbols, determine if the designated symbol is indicated by the viewable area of the outer reel of the first reel set, wherein if the designated symbol is indicated by the viewable area:
(i) cause the outer reel to move and indicate at least one of the second symbols,
(ii) cause the second symbol including the wild symbol to substitute for at least one of the first symbols on the inner reel or the second symbols on the outer reel if the second symbol including the wild symbol is indicated by the outer reel of the first reel set,
(iii) evaluate the second symbols indicated by the outer reel of the first reel set and the first symbols indicated by the second reel set;
(iv) provide an outcome based on the second symbols indicated by the first reel set and the first symbols indicated by the second reel set;
wherein if the designated symbol is not indicated by the viewable area:
(v) evaluate the first symbols indicated by the viewable area of the first reel set and the first symbols indicated by the second reel set, and
(vi) provide an outcome based on the indicated first symbols.

27. The gaming device of claim 26, wherein a plurality of the second symbols on the outer reel of the first reel set include a wild symbol.

28. The gaming device of claim 26, wherein a all of the second symbols on the outer reel of the first reel set include a wild symbol.

29. The gaming device of claim 26, wherein at least one of the first symbols of the second reel set includes a wild symbol.

30. The gaming device of claim 26, wherein the designated symbol includes a wild symbol.

31. The gaming device of claim 26, wherein a plurality of the first symbols on the inner reel include designated symbols.

32. The gaming device of claim 31, wherein at least one of the designated symbols includes a wild symbol.

33. The gaming device of claim 26, wherein the designated symbol causes the processor to change at least one of the first symbols on the inner reel to a wild symbol if the designated symbol is indicated by the viewable area on the outer reel.

34. The gaming device of claim 26, wherein the designated symbol causes the processor to change a plurality of the first symbols on the inner reel to wild symbols if the designated symbol is indicated by the viewable area on the outer reel.

35. The gaming device of claim 26, wherein the designated symbol causes the processor to change all of the first symbols on the inner reel to wild symbols if the designated symbol is indicated by the viewable area on the outer reel.

36. The gaming device of claim 26, wherein at least one of the second symbols on the outer reel of the first reel set includes a modifier.

37. The gaming device of claim 26, wherein a plurality of the second symbols on the outer reel of the first reel set include a modifier.

38. The gaming device of claim 37, wherein all of the second symbols on the outer reel of the first reel set include modifiers.

39. The gaming device of claim 26, which includes at least one payline associated with the first and second reel sets.

40. The gaming device of claim 39, wherein the outcome is based on at least one of the first symbols and the second symbols indicated by the payline.

41. The gaming device of claim 26, which includes a plurality of paylines associated with the first and second reel sets.

42. The gaming device of claim 41, wherein the outcome is based on at least one of the first symbols and the second symbols indicated by one of the paylines.

43. The gaming device of claim 26, wherein the second reel set includes the inner reel and the outer reel.

44. The gaming device of claim 26, wherein the outer reel of the first reel set is substantially transparent.

45. The gaming device of claim 26, wherein at least one of the first and second symbols are the same.

46. The gaming device of claim 26, wherein a plurality of the first and second symbols are the same.

47. The gaming device of claim 26, wherein the processor is operable to hold the outer reel of the first reel set stationary to enable the player to view at least one of the first symbols on the inner reel until the designated symbol is indicated by the viewable area.

48. The gaming device of claim 47, wherein the processor is operable to hold the outer reel of the first reel set stationary for a designated number of activations of the reel sets.

49. The gaming device of claim 47, wherein the processor is operable to hold the outer reel of the first reel set stationary for a randomly determined number of activations of the reel sets.

50. A gaming device controlled by a processor, said gaming device comprising:
a game operable upon a wager made by a player;
at least one first reel set including an inner reel and an outer reel in said game, said inner reel including a plurality of first symbols, said first symbols including at least one designated symbol, said outer reel including a plurality of modifiers and defining at least one viewable area, said outer reel positioned to enable a player to view at least one of the first symbols on the inner reel, wherein the designated symbol is activatable upon an additional wager made by the player in the game; and
at least one second reel set including a plurality of the first symbols;
wherein the processor is operable to cause the inner reel of said first reel set to generate at least one of the first symbols, cause the second reel set to generate at least one of the first symbols and determine if the designated symbol is indicated by the viewable area defined by the outer reel of said first reel set,
wherein if the designated symbol is indicated by the viewable area and the player has made the additional wager:
(i) activate the designated symbol;
(ii) cause the outer reel to move and indicate at least one of the modifiers;
(iii) evaluate the modifiers indicated by the outer reel of the first reel set and the first symbols indicated by the second reel set; and
(iv) provide an outcome based on at least one of the indicated first symbols and indicated modifiers; and
wherein if the designated symbol is not indicated by the viewable area:
(v) evaluate the first symbols indicated by the viewable area of the first reel set and the first symbols indicated by the second reel set, and
(vi) provide an outcome based on the indicated first symbols.

51. The gaming device of claim 50, wherein the designated symbol includes a wild symbol.

52. The gaming device of claim 50, wherein a plurality of the first symbols on the inner reel include designated symbols.

53. The gaming device of claim 52, wherein at least one of the designated symbols includes a wild symbol.

54. The gaming device of claim 50, which includes at least one payline associated with the first and second reel sets.

55. The gaming device of claim 54, wherein the outcome is based on at least one of the first symbols and modifiers indicated by the payline.

56. The gaming device of claim 50, which includes a plurality of paylines associated with the first and second reel sets.

57. The gaming device of claim 56, wherein the outcome is based on at least one of the first symbols and modifiers indicated by one of the paylines.

58. The gaming device of claim 50, wherein the second reel set includes the inner reel and the outer reel.

59. The gaming device of claim 50, wherein the outer reel of the first reel set is substantially transparent.

60. The gaming device of claim 50, wherein the processor is operable to hold the outer reel of the first reel set stationary to enable the player to view at least one of the first symbols on the inner reel until the designated symbol is indicated by the viewable area.

61. The gaming device of claim 50, wherein the processor is operable to hold the outer reel of the first reel set stationary for a designated number of activations of the reel sets.

62. The gaming device of claim 50, wherein the processor is operable to hold the outer reel of the first reel set stationary for a randomly determined number of activations of the reel sets.

63. The gaming device of claim 50, wherein the processor is operable to enable the player to place an additional wager in the game to display at least one of the modifiers on the outer reel of each reel set including the inner reel and the outer reel.

64. The gaming device of claim 50, wherein the processor is operable to enable the player to place an additional wager in the game to activate at least one of the modifiers on the outer reel of each reel set including the inner reel and the outer reel.
